(19) United States
(12) Patent Application Publication
(10) Pub. No.: US 2014/0046790 A1
(43) Pub. Date: Feb. 13, 2014

(54) INFORMATION PROVIDING APPARATUS, INFORMATION PROVIDING METHOD, INFORMATION PROVIDING PROGRAM, AND COMPUTER-READABLE RECORDING MEDIUM HAVING INFORMATION PROVIDING PROGRAM RECORDED THEREIN

(71) Applicant: Sadaaki Emura, Shinagawa-ku (JP)

(72) Inventor: Sadaaki Emura, Shinagawa-ku (JP)

(73) Assignee: RAKUTEN, INC., Shinagawa-ku, Tokyo (JP)

(21) Appl. No.: 14/008,444

(22) PCT Filed: Mar. 31, 2012
(86) PCT No.: PCT/JP2011/058262

§ 371 Date: Nov. 4, 2013

(51) Int. Cl. G06Q 30/08

(52) U.S. Cl. CPC G06Q 30/08
USPC 705/26.3

(57) ABSTRACT

An object is to provide useful information for determining an auction end time to an exhibitor who wishes to determine the auction end time. Accordingly, a server 11 includes an access number calculation unit 76, an auction detection unit 77, and an estimation unit 75. The access number calculation unit 76 obtains the number of accesses of every predetermined time to past auctions for other products based on action time information. The auction detection unit 77 detects the number of held auctions of the other products and end dates and times thereof based on the auction information. The estimation unit 75 identifies an auction holding period based on the number of accesses of every predetermined time for past auctions and the number and the end dates and times of held auctions, and provides data indicating the auction holding period to a user terminal 13 of the exhibitor.

### TECHNICAL FIELD

The present invention relates to an information providing device, an information providing method, an information providing program, and a computer-readable recording medium having the program recorded thereon.

### BACKGROUND ART

In recent years, provision of service of an auction via the Internet is being widely performed. An auction allows buyers to compete for purchase conditions. In an auction via the Internet, a provider that provides service of an auction prepares a web page on which to compete for products. Further, when exhibitors propose exhibition of products in the web page, bidders (bid applicants) who are buyers present a purchase price. Further, the bidder who has presented the highest purchase price by the end date and time can win the bid for the product.

When a product is exhibited for an auction, an exhibitor often designates date and time when bidders are highly likely to be active at the auction as end date and time. Specifically, the exhibitor often sets an end day of the auction as a weekend and/or an end time within a range from 22:00 to 24:00. This is because many people are unoccupied during such times, the number of bids of the auction generally increases, and accordingly price of products is highly likely to rise.

A scheme for determination of the end time is conventionally considered. For example, a net auction server that stores information including statistical information of a bid for each product name and determines a bid end time of a net auction based on the stored statistical information of a bid for each product name when an exhibition request is acquired from a device of an exhibitor via a network is disclosed in following Patent Literature 1.

### CITATION LIST

### Patent Literature

Patent Literature 1: Japanese Patent Laid-Open No. 2005-196418

### SUMMARY OF INVENTION

### Technical Problem

However, in the server disclosed in Patent Literature 1 described above, it is difficult to accurately obtain the end times for all products in a real auction service in which various kinds of products are handled since the end times are determined based on statistical information of bids of each article.

The present invention has been made in view of such circumstances and an object of the present invention is to provide useful information for determining an auction end time to an exhibitor who wishes to determine the auction end time.

### Solution to Problem

An information providing device according to the present invention includes an access number calculation means that obtains the number of accesses to past auctions of every predetermined time period for other products belonging to a category of a product that an exhibitor wishes to exhibit for an auction, based on action date and time information corresponding to the past auctions with reference to a storage means that stores end date and time information indicating dates and times when auctions of the other products end and the action date and time information indicating dates and times when participants have accessed the past auctions of the other products; an auction detection means that detects the number and end dates and times of held auctions of the other products based on the end date and time information in the storage means; an auction holding period identifying means that identifies an auction holding period of the exhibitor based on the number of accesses calculated by the access number calculation means and the number and the end dates and times of the held auctions detected by the auction detection means; and a providing means that provides the auction holding period identified by the auction holding period identifying means to a terminal of the exhibitor.

An information providing method according to the present invention is an information providing method executed by an information providing device, the method includes an access number calculating step of obtaining the number of accesses to past auctions of every predetermined time period for other products belonging to a category of a product that an exhibitor wishes to exhibit for an auction, based on action date and time information corresponding to the past auctions with reference to a storage means that stores end date and time information indicating dates and times when auctions of the other products end and the action date and time information indicating dates and times when participants have accessed the past auctions of the other products; an auction detecting step of detecting the number and end dates and times of held auctions of the other products based on the end date and time information in the storage means; an auction holding period identifying step of identifying an auction holding period of the exhibitor based on the number of accesses calculated by the access number calculation means and the number and the end dates and times of the held auctions detected by the auction detection means; and a providing step of providing the auction holding period identified by the auction holding period identifying means to a terminal of the exhibitor.

An information providing program according to the present invention causes a computer to function as: an access number calculation means that obtains the number of accesses to past auctions of every predetermined time period for other products belonging to a category of a product that an exhibitor wishes to exhibit for an auction, based on action date and time information corresponding to the past auctions with reference to a storage means that stores end date and time information indicating dates and times when auctions of the other products end and the action date and time information indicating dates and times when participants have accessed the past auctions of the other products; an auction detection means that detects the number and end dates and times of held auctions of the other products based on the end date and time information in the storage means; an auction holding period identifying means that identifies an auction holding period of the exhibitor based on the number of accesses calculated by the access number calculation means and the number and the end dates and times of the held auctions detected by the auction detection means; and a providing means that provides the auction holding period identified by the auction holding period identifying means to a terminal of the exhibitor.

A computer-readable recording medium according to the present invention has an information providing program recorded thereon for causing a computer to function as: an access number calculation means that obtains the number of accesses to past auctions of every predetermined time period for other products belonging to a category of a product that an exhibitor wishes to exhibit for an auction, based on action date and time information corresponding to the past auctions with reference to a storage means that stores end date and time information indicating dates and times when auctions of the other products end and the action date and time information indicating dates and times when participants have accessed the past auctions of the other products; an auction detection means that detects the number and end dates and times of held auctions of the other products based on the end date and time information in the storage means; an auction holding period identifying means that identifies an auction holding period of the exhibitor based on the number of accesses calculated by the access number calculation means and the number and the end dates and times of the held auctions detected by the auction detection means; and a providing means that provides the auction holding period identified by the auction holding period identifying means to a terminal of the exhibitor.

According to this invention, the auction holding period is identified based on information on auctions of other products belonging to the category of the product (hereinafter referred to as “other auctions”) exhibited by the exhibitor (hereinafter referred to as an “exhibition product”). Specifically, the auction holding period is identified based on the number of accesses to the past other auctions and the number of the other held auctions and the end date and time of the other held auctions. By providing this auction holding period to the exhibitor, the exhibitor can determine the end date and time in consideration of the auction holding period. In other words, it is possible to provide useful information for determining an auction end time to the exhibitor who wishes to determine the auction end time.

In the information providing device according to the present invention, the auction holding period identifying means may identify the auction holding period based on a ratio of the number of accesses in a predetermined time period and the number of held auctions that end in the predetermined time period.

In this case, the auction holding period is identified based on the ratio of the number of accesses to the past other auctions in a predetermined time period and the number of held auctions that end in the time period. By providing the auction held period identified using such a ratio to the exhibitor, the exhibitor can determine the end date and time in consideration of the auction holding period. In other words, it is possible to provide useful information for determining an auction end time to the exhibitor who wishes to determine the auction end time.

In the information providing device according to the present invention, the auction holding period identifying means may identify, as the auction holding period, a time period in which the ratio of the number of held auctions that end in the predetermined time period to the number of accesses in the predetermined time period is small.

In this case, the time period in which many accesses to the auction of the exhibition product are expected and the end time hardly overlaps end times of other auctions is identified as the auction holding period. By providing this auction holding period to the exhibitor, the exhibitor can determine the end date and time in consideration of the auction holding period. In other words, it is possible to provide useful information for determining an auction end time to the exhibitor who wishes to determine the auction end time.

In the information providing device according to the present invention, the action date and time information may further include user evaluation information indicating evaluation of participants, and when there are a plurality of auction holding periods, the providing means may give a priority to the plurality of auction holding periods based on evaluation of the participants with reference to the user evaluation information of the participants who accessed the past auctions.

In this case, the time period in which participants having high evaluation participate in an auction is preferentially provided as the prediction time period, and the exhibitor can determine the end date and time in consideration of the auction holding period. In other words, it is possible to provide useful information for determining an auction end time to the exhibitor who wishes to determine the auction end time.

### Advantageous Effects of Invention

According to the present invention, it is possible to provide useful information for determining the auction end time to the exhibitor who wishes to determine the auction end time.

### BRIEF DESCRIPTION OF DRAWINGS

FIG. 1 is a diagram illustrating a configuration of an information providing system according to a first embodiment;

FIG. 2 is a block diagram illustrating a hardware configuration of a server according to the first embodiment;

FIG. 3 is a block diagram illustrating a functional configuration of a server according to the first embodiment;

FIG. 4 is a diagram illustrating an example of auction information;

FIG. 5 is a diagram illustrating an example of estimating a prediction time period;

FIG. 6 is a sequence diagram illustrating a prediction time period estimation process in the first embodiment;

FIG. 7 is a block diagram illustrating a functional configuration of a server according to a second embodiment;

FIG. 8 is a diagram illustrating an example of action time information;

FIG. 9 is a flowchart indicating a process of updating an evaluation value;

FIG. 10 is a diagram illustrating correspondence of an evaluation value and an evaluation stage;

FIGS. 11(a) and 11(b) are diagrams illustrating an example of estimation of a prediction time period;

FIG. 12 is a sequence diagram illustrating a prediction time period estimation process in a second embodiment;

FIG. 13 is a block diagram illustrating a functional configuration of a server according to a third embodiment;

FIG. 14 is flowchart indicating a process of storing action totaling information;

FIG. 15 is a diagram illustrating an example of the action totaling information;

FIG. 16 is a diagram illustrating an example of the action totaling information;

FIGS. 17(a) to 17(c) are diagrams illustrating an example of estimation of a prediction time period;

FIG. 18 is a sequence diagram illustrating a prediction time period estimation process in the third embodiment;

FIG. 19 is a diagram illustrating another example of action totaling information;

FIG. 20 is a block diagram illustrating a functional configuration of a server according to a fourth embodiment;

FIG. 21 is a sequence diagram indicating a prediction time period estimation process in the fourth embodiment;

FIG. 22 is a diagram illustrating a configuration of an information providing system according to a fifth embodiment;

FIGS. 23(a) and 23(b) are diagrams illustrating examples of calculation of the number of accesses to an auction;

FIGS. 24(a) and 24(b) are diagrams illustrating an example in which the number of ended auctions is detected every predetermined time; and

FIG. 25 is a sequence diagram illustrating a prediction time period estimation process in the fifth embodiment.

### DESCRIPTION OF EMBODIMENTS

Hereinafter, an embodiment of the present invention will be described in detail with reference to the accompanying drawings. In the present embodiment, an information providing device according to the present invention is applied to a server. Further, the same or equivalent elements are denoted by the same reference numerals in describing the drawings and a repeated description will be omitted.

### First Embodiment

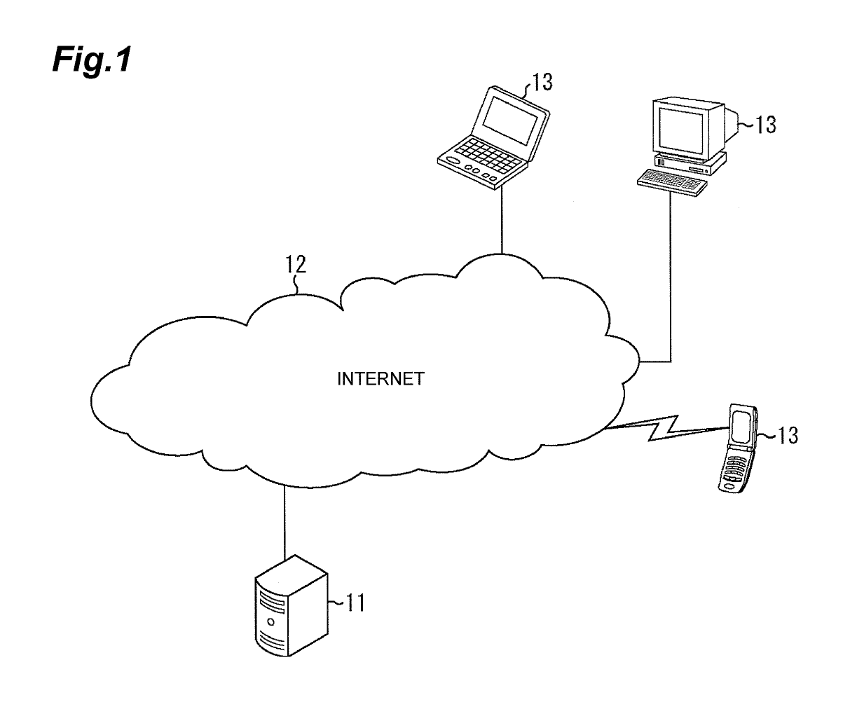

First, an information providing system according to a first embodiment will be described. The information providing system is a computer system that provides auction service to users, and includes a server 11, the Internet 12, and one or more user terminals 13, as shown in FIG. 1. The server 11 and each user terminal 13 can communicate with each other via the Internet 12.

The server 11 is an information providing device including a dedicated server, a personal computer, or a virtual server. The server 11 may be a system that is a combination of a dedicated server, a personal computer, a virtual server, and the like. The server 11 provides the auction service to the user of the user terminal 13 by providing a web page for an auction to the user terminal 13. Further, the server 11 estimates a time period other than a time period in which auctions the number of which is equal to or more than a predetermined threshold are predicted to end, as a prediction time period (an auction holding period), and provides data indicating this prediction time period to each user terminal 13.

The Internet 12 is an example of a network, and includes a wired or wireless general-purpose or dedicated line or a plurality of wired or wireless networks (e.g., LAN (Local Area Network) and WAN (Wide Area Network)).

The user terminal 13 presents a web page for an auction to the user of the user terminal 13 by acquiring the web page for an auction from the server 11 and displaying the web page in response to a manipulation of the user. Accordingly, the user can perform an exhibition or a bid of a product for an auction by manipulating the web page. Examples of the user terminal 13 include a portable or stationary personal computer, any portable terminal, and the like, but the type of terminal is not particularly limited.

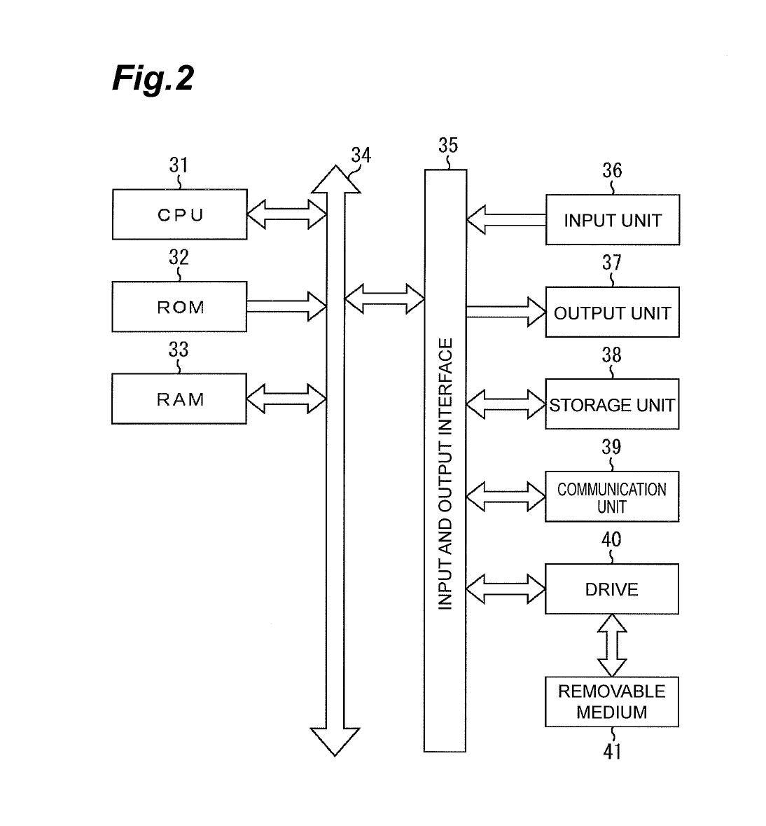

Next, the server 11 will be described in detail. FIG. 2 is a block diagram illustrating a configuration example of hardware of the server 11. In the server 11, a CPU (Central Processing Unit) 31, a ROM (Read Only Memory) 32, and a RAM (Random Access Memory) 33 are interconnected by a bus 34. Further, an input and output interface 35 is connected to the bus 34. An input unit 36 including a keyboard, a mouse, a microphone or the like, an output unit 37 including a display, a speaker or the like, a storage unit 38 including a hard disk or a nonvolatile memory, a communication unit 39 including a network interface or the like, and a drive 40 that drives a removable medium 41 such as a magnetic disk, an optical disc, a magneto optical disc or a semiconductor memory are connected to the input and output interface 35.

In the server 11 (computer) configured as above, for example, the CPU 31 loads an information providing program stored in the storage unit 38 to the RAM 33 via the input and output interface 35 and the bus 34, and executes the information providing program to perform a series of processes, which will be described below.

The information providing program may also be provided by the removable medium 41 such as a magnetic disk (including a flexible disk), an optical disc (e.g., a CD-ROM (Compact Disc-Read Only Memory) or a DVD (Digital Versatile Disc)), a magneto optical disc or a semiconductor memory. Further, the information providing program may also be provided via a wired or wireless transmission medium, such as a local area network, the Internet 12, or digital satellite broadcasting.

The information providing program may be installed in the computer by mounting the removable medium 41 on the drive 40 and storing the information providing program in the storage unit 38 via the input and output interface 35. Further, the information providing program may be installed in the computer by being received by the communication unit 39 via the wired or wireless transmission medium and stored in the storage unit 38. Further, the information providing program may also be installed in advance by being stored in the ROM 32 or the storage unit 38 in advance.

Further, the information providing program may be a program that causes the computer to perform processes in time series in an order that will be described below, or may be a program that causes the computer to perform processes in parallel or at a necessary timing such as when a call has been performed. Information providing devices shown in first to fifth embodiments that will be described below are realized by executing such an information providing program.

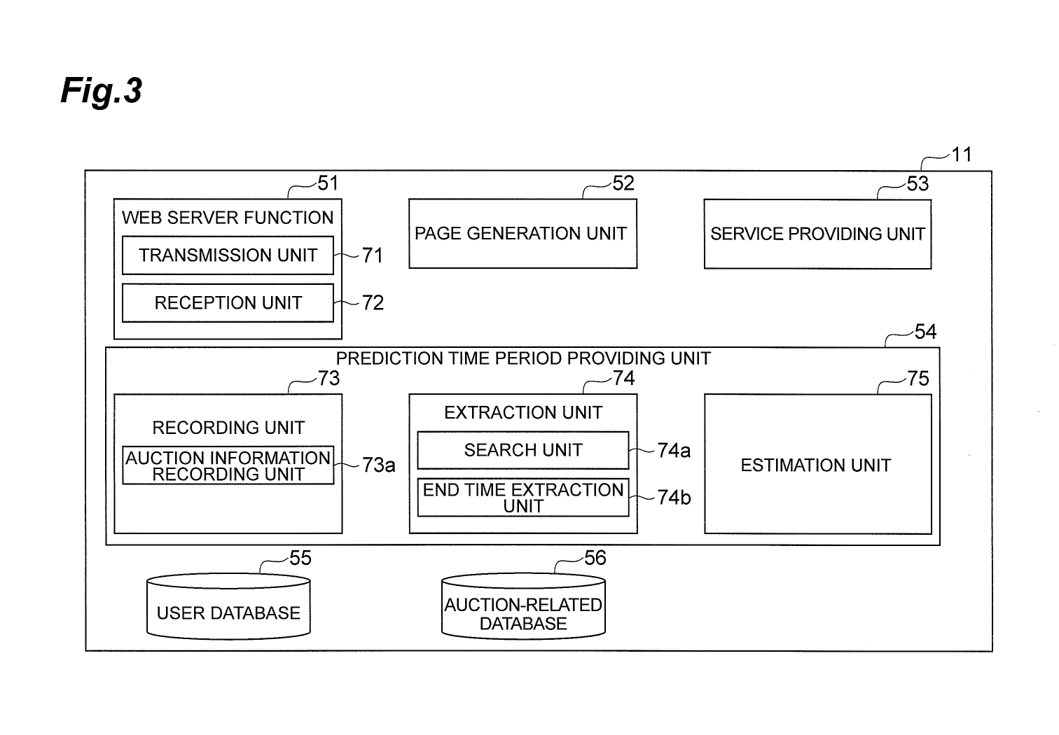

FIG. 3 is a block diagram illustrating a functional configuration of the server 11. The server 11 includes a Web server function 51, a page generation unit 52, a service providing unit 53, a prediction time period providing unit 54, a user database 55, and an auction-related database (a storage means) 56.

The Web server function 51 is realized by executing a predetermined Web server program, and provides a web page in which various objects such as text or images are included based on a procedure defined in HTTP (Hypertext Transfer Protocol). The web page is described in HTML (Hypertext Markup Language) or XML (Extensible Markup Language). The web server function 51 includes a transmission unit 71 and a reception unit 72. The transmission unit 71 transmits the web page to the user terminal 13. The reception unit 72 receives various data transmitted from the user terminal 13.

The page generation unit 52 generates a web page to be provided to the user terminal 13 and outputs the web page to the transmission unit 71 of the web server function 51. A web page for presenting the prediction time period to an exhibitor is also included in this web page.

The service providing unit 53 receives an event indicating login and logout for auction service or various actions at the auction. This event indicates a user ID identifying a user participating in the auction and information indicating an action (e.g., login, logout, bid, successful bid, or exhibition) of the user.

The prediction time period providing unit 54 estimates a time period other than a time period in which auctions the number of which is equal to or more than a predetermined threshold are predicted to end. Generally, since bids occur most actively directly before the auction end, the number of auctions that end in the same time period being great means that there are many rivals for an exhibitor. As a result, the rise in price of an exhibition product is not readily expected. Accordingly, the prediction time period providing unit 54 estimates a time period in which the number of rivals of the exhibitor is not so great.

The prediction time period providing unit 54 presents the prediction time period to the exhibitor by providing the prediction time period to the user terminal 13 of the exhibitor via the page generation unit 52 and the web server function 51. Here, the prediction time period may be a time period in which 30 minutes, one hour, two hours or the like of the day is used as a unit, or may be a time period in which a day of the week is considered such as “between 12:00 and 13:00 on Sunday.” A type of prediction time period to be provided may be arbitrarily determined.

The user database 55 stores data (user data) about users who use the auction service. The user data is data in which user IDs for identifying the users and various attributes such as a name, an address, a phone number, an e-mail address, an age, a sex and a password for login of the user are associated with each other.

The auction-related database 56 stores information on the auction (auction information). The auction information includes an auction ID for identifying an auction, a user ID of an exhibitor, a product ID identifying an exhibited product, a name and a category of the product, a start price at the auction, a date and time of start and end of the auction (end date and time information), a user ID identifying a user (a bidder) who has bid for the product, a bid date and time, a user ID identifying a successful bidder of the product, and a successful bid date and time. Since a bid may occur for one product several times, user IDs of a plurality of bidders and bid dates and times may be included in one piece of auction information. The category of the product means a type of product. For example, home appliance, interior, household goods, food, and the like correspond to the category. The category may be represented hierarchically as in “food-sweets-confectionery-chocolate.”

The auction information may further include a user ID identifying a user who registered an auction in a watch list, and a user ID identifying a user who registered a remind mail for an auction. The user who registered an auction in the watch list may be a user who is interested in the auction or pays attention to the auction.

Various user IDs included in the auction information may be said to be participant IDs identifying participants of the auction.

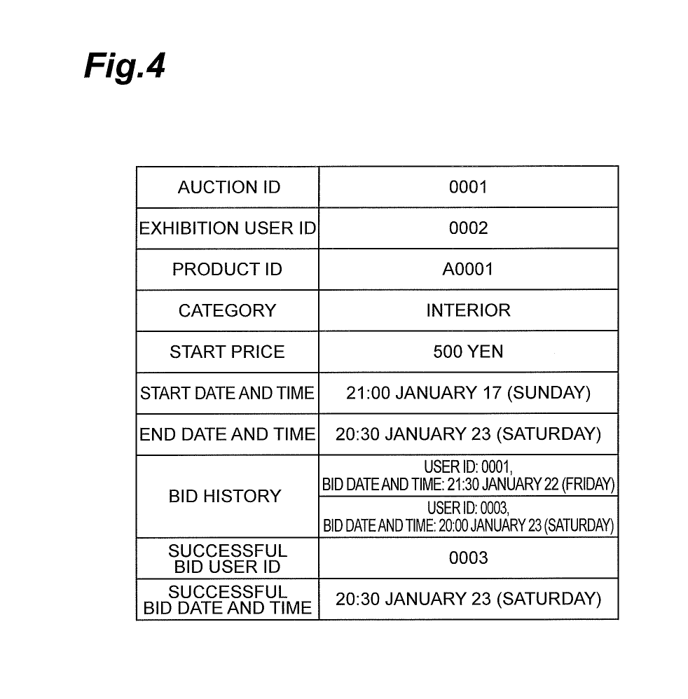

In FIG. 4, an example of the auction information stored in the auction-related database 56 is shown. In the example shown in FIG. 4, user IDs of exhibitors, bidders and successful bidders are stored as participant IDs. The auction information is updated when a product is newly exhibited or when a product of an auction is bid for or successfully bid for by the participant.

Referring again to FIG. 3, the prediction time period providing unit 54 will be described in detail. The prediction time period providing unit 54 includes a recording unit 73, an extraction unit (estimation means) 74, and an estimation unit (estimation means; providing means) 75.

The recording unit 73 updates the auction information in the auction-related database 56. This recording unit 73 includes an auction information recording unit 73a.

The auction information recording unit 73a records information on the auction with reference to the event received by the service providing unit 53. When the event indicates exhibition of a product, the auction information recording unit 73a generates new auction information identifying an auction for the exhibition product, and registers this auction information in the auction-related database 56. When the event indicates a successful bid for the product, the auction information recording unit 73a registers a user ID of a successful bidder and a successful bid date and time in the corresponding auction information on the auction. When the event indicates a bid for a product, the auction information recording unit 73a adds a record including a user ID of a bidder and a bid date and time to the corresponding bid history of the auction information about the auction.

The extraction unit 74 extracts end times of auctions of other products belonging to a category of the exhibition product with reference to the auction-related database 56. The extraction unit 74 includes a search unit 74a and an end time extraction unit 74b.

The search unit 74a acquires category information indicating the category of the exhibition product transmitted from the user terminal 13 of the exhibitor. The search unit 74a then extracts the auction information indicating auctions (other auctions) for which other products belonging to the category indicated by the category information have been exhibited, from the auction-related database 56. In this case, the search unit 74a may extract only auction information further satisfying an additional condition that an auction end on the same day as an auction end day (with no designation of a time) designated by the exhibitor.

The end time extraction unit 74b extracts the end times from the auction information extracted by the search unit 74a and outputs a set of end times to the estimation unit 75.

The estimation unit 75 estimates, as the prediction time period, a time period in which the end time hardly overlaps the end times of the other auctions, and transmits the prediction time period to the user terminal 13.

The estimation unit 75 estimates candidates of the time period in which the end time hardly overlaps the end times of auctions of the other products belonging to the category of the exhibition product (candidates of the prediction time period; hereinafter also referred to as “candidate time periods”) based on the input set of end times. Specifically, the estimation unit 75 divides the input end time every predetermined time to calculate the number of auctions that end within the time. For example, the estimation unit 75 calculates the number of auctions every predetermined length of time of one day. The estimation unit 75 then estimates, as the candidate time period, a time period other than a time period (rush hour) in which auctions the number of which is equal to or more than a predetermined threshold are predicted to end.

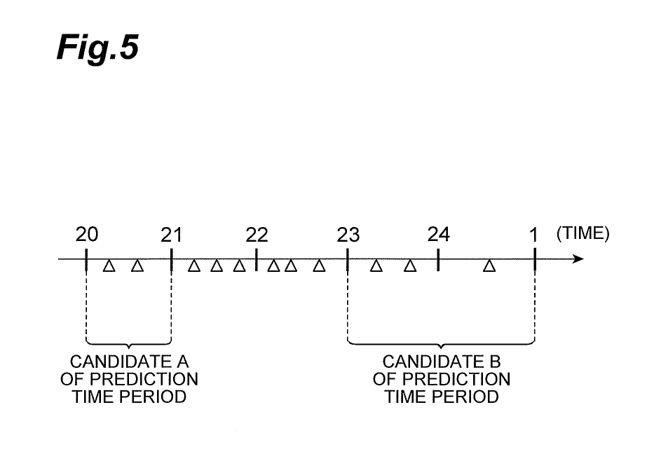

This estimation process will be described in detail with reference to FIG. 5. A triangle mark in FIG. 5 indicates an end time extracted by the end time extraction unit 74b. In FIG. 5, the end time is set at two auctions from 20:00 to 21:00, and three auctions from 21:00 to 22:00. The same is considered for other time periods.

The estimation unit 75 identifies the time period (rush hour) in which the number of other auctions is equal to or more than the predetermined threshold, and sets time periods other than the identified time as the prediction time period candidates. In the example of FIG. 5, if the threshold is 3, the estimation unit 75 identifies 21:00 to 23:00 as the rush hour and sets time periods other than this time period, i.e., “20:00 to 21:00” (candidate A of the prediction time period) and “23:00 to 1:00” (candidate B of the prediction time period) as the candidate time periods. The threshold used in this process may be an absolute number of auctions that end within a predetermined time period or may be a ratio of the number of ended auctions to a total number of auctions accepting a bid in a predetermined time period. Further, the estimation unit 75 may identify a time period in which the number of other auctions is equal to or more than a predetermined threshold, and set time periods other than the identified time periods whose difference with the identified time period is within a predetermined value as prediction time period candidates.

When there are a plurality of acquired candidate time periods, the estimation unit 75 may select only the candidate time period after the identified time as a final prediction time period. This is because this prediction time period is a time period in which a participant who was not able to successfully bid for a product at other auctions is expected to participate in the auction of the exhibition product. In the example of FIG. 5, the estimation unit 75 selects “23:00 to 1:00” as the prediction time period. Further, the estimation unit 75 may also select only the candidate time period before the identified time period as the final prediction time period. This is because this prediction time period is a time period in which many participants are expected to participate in an auction, next to a time period when many auctions end. In the example of FIG. 5, the estimation unit 75 may select “20:00 to 21:00” as the prediction time period. Further, the estimation unit 75 may select the candidate time period in which there is the smallest number of auctions that end within the time period as the prediction time period. In the example of FIG. 5, even in this case, the estimation unit 75 selects “23:00 to 1:00” as the prediction time period. The estimation unit 75 outputs the prediction time period obtained in this way to the page generation unit 52.

The estimation unit 75 may determine one or more candidate time periods as one or more prediction time periods, and output the prediction time periods to the page generation unit 52. When there are a plurality of candidate time periods, the estimation unit 75 may sort the candidate time periods using the following method and output the candidate time periods to the page generation unit 52. For example, the estimation unit 75 may sort the candidate time periods so that the candidate time period located before the identified time period (a time period in which auctions the number of which is equal to more than a certain number end) is first displayed. Further, the estimation unit 75 may sort the candidate time periods in order of the candidate time periods in which the number of auctions that end within the time period is smaller. Through such a process, the prediction time period before the identified time period or the prediction time period in which the number of auctions that end is smaller is preferentially presented to the exhibitor.

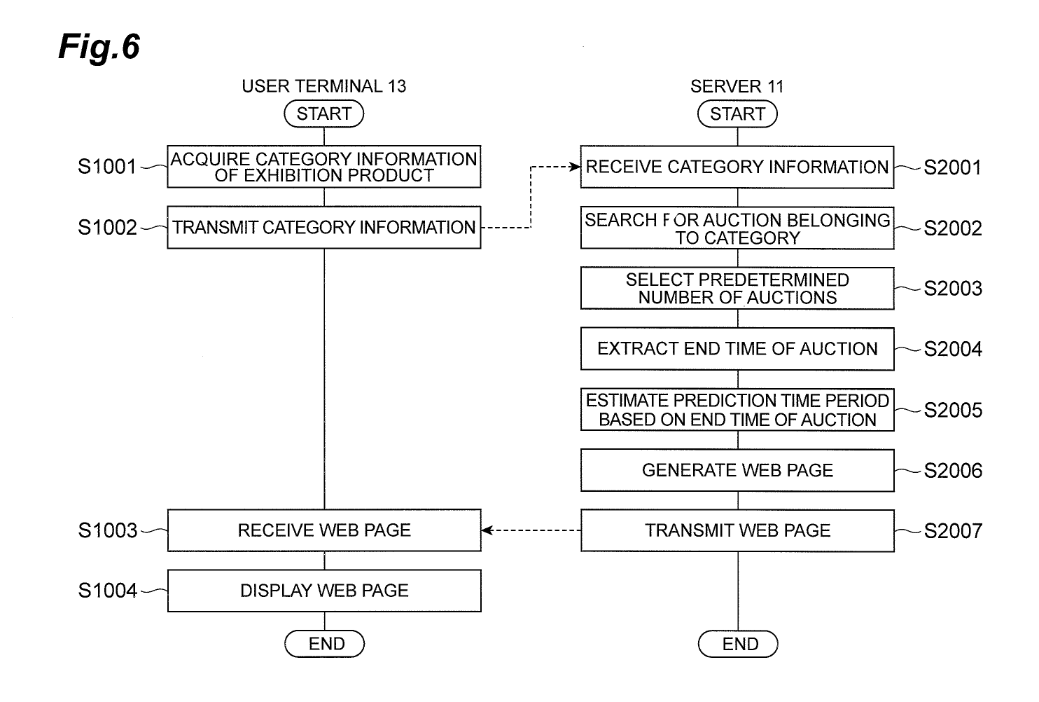

Next, a prediction time period estimation process (an information providing method) in the present embodiment will be described with reference to FIG. 6. First, the user terminal 13 of the exhibitor acquires category information indicating the category of the exhibition product (S1001). Specifically, the user terminal 13 acquires category information selected from a pull-down menu in a web page for accepting exhibition for auction, or directly input category information. The user terminal 13 then transmits the category information to the server 11 (S 1002). If an auction end day input by the exhibitor is used in the server 11, the end day is also acquired and transmitted in steps S1001 and S1002.

In the server 11, the reception unit 72 receives the category information and outputs the category information to the prediction time period providing unit 54 (S2001).

In the prediction time period providing unit 54, the search unit 74a searches for auctions of products that belong to the category indicated by the category information and currently receive a bid (S2002). The extraction unit 74 then selects a predetermined number of auctions from among the searched auctions (S2003). For example, the extraction unit 74 may select ten data from the searched auctions at random or may select all of the searched auctions. The end time extraction unit 74b then extracts the end times of the auctions based on the auction information of the selected auctions (S2004; identifying step).

Based on the extracted end times, the estimation unit 75 then totals the number of auctions that end hourly. Further, the estimation unit 75 identifies candidate time periods based on a totaling result and estimates the prediction time period based on the candidate time periods (S2005; estimating step). As described above, some estimation schemes may be considered.

The page generation unit 52 then generates a web page including the prediction time period (S2006). The page generation unit 52 may generate, for example, a web page showing the prediction time period using a time axis as shown in FIG. 5, but a method of showing the prediction time period in the web page is not particularly limited. The transmission unit 71 of the web server function 51 transmits the web page to the user terminal 13 (S2007; providing step).

The user terminal 13 receives the web page that has been transmitted from the server 11 (S1003) and displays the web page (S 1004).

Thus, the exhibitor can confirm, for example, the prediction time period displayed as shown in FIG. 5 to determine an appropriate end time. For example, the exhibitor can determine, as the end time, a specific time within the time period (the prediction time period) in which the end time hardly overlaps end times of the auctions of other products.

As described above, according to the present embodiment, the time period in which the end time hardly overlaps the end times of the auctions of other products belonging to the category of the product exhibited by the exhibitor is estimated as the prediction time period. By providing this prediction time period to the exhibitor, the exhibitor can determine end date and time in consideration of the prediction time period. In other words, it is possible to provide useful information for determining the end time to the exhibitor who wishes to determine the auction end time.

### Second Embodiment

Next, an information providing system according to a second embodiment will be described. This information providing system is different from that in the first embodiment in that the prediction time period is estimated based on action time information indicating a time when participants of an auction have accessed the auction. Accordingly, the information providing system of the present embodiment includes a server 11A in place of the server 11. Hereinafter, description of matters that are the same as or equivalent to those in the first embodiment will be omitted.

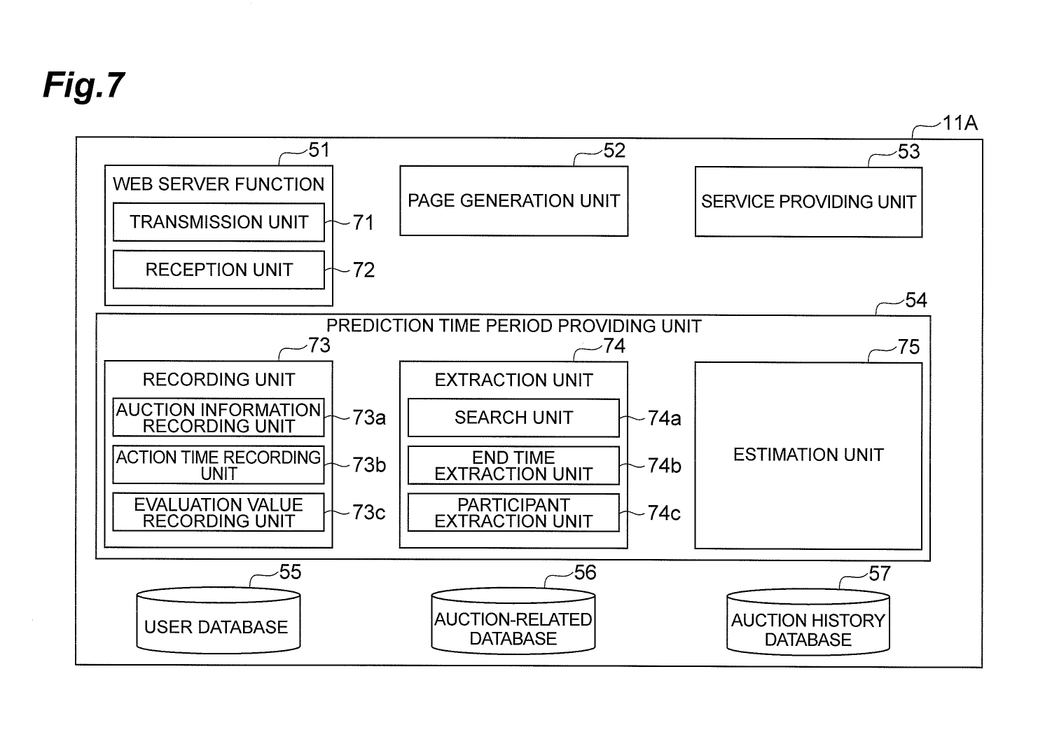

A functional configuration of the server 11A is shown in FIG. 7. The server 11A is different from the server 11 in that the server 11A further includes an auction history database 57 (a storage means) and further includes an action time recording unit 73b and an evaluation value recording unit 73c in the recording unit 73. Further, the extraction unit 74 further includes a participant extraction unit 74c. In response thereto, operations of some functional components are also different from those in the first embodiment.

The auction history database 57 stores action time information (action date and time information) indicating a time when individual users have accessed an auction.

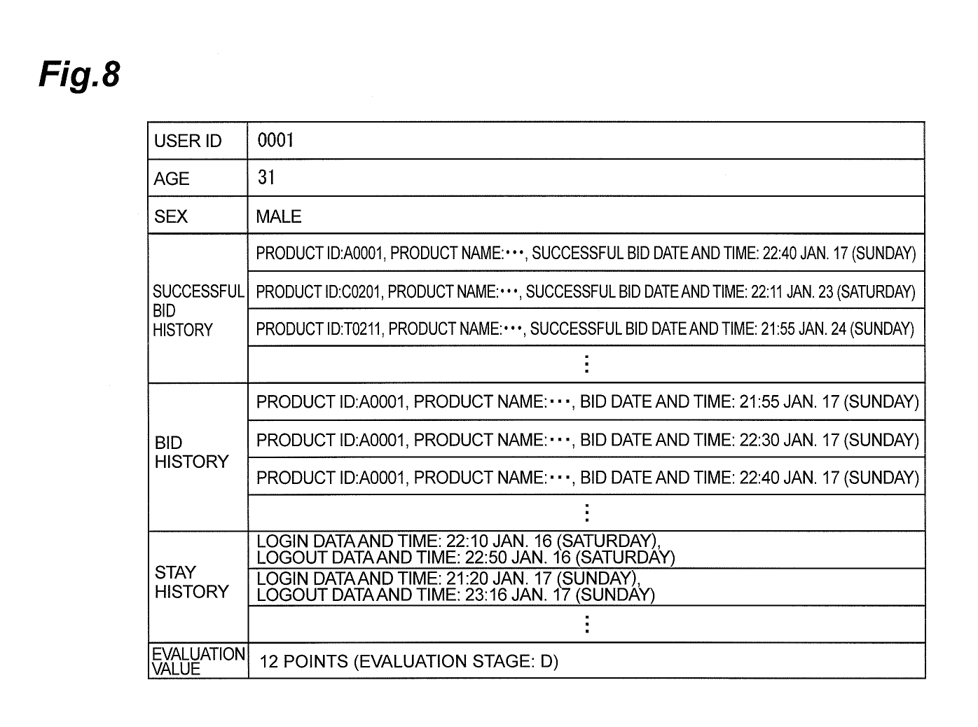

As shown in FIG. 8, the action time information includes a user ID identifying a user who has participated in an auction, an age and sex of the user, an action history (a successful bid history, a bid history, and a stay history) of the user, and an evaluation value of the user. The successful bid history is information indicating a product ID identifying a product successfully bid for by the user, a name (a brand name) of the product, and a successful bid date and time. The bid history is information indicating an ID and a name of a product bid for by the user, and a bid date and time. Such an action history indicates that the user has accessed the auction. The stay history is information indicating a date and time when the user logs into an auction service and a date and time when the user logs out of the service. The evaluation value is user evaluation information indicating an evaluation by other persons for the action of the user in the auction service, and a greater value means that the user is desirable as a trading partner. Further, an initial value of the evaluation value is 0. An evaluation stage is user evaluation information set corresponding to the evaluation value and is used to divide the evaluation value in a stepwise manner in a predetermined width and show the evaluation roughly.

For example, it can be seen, from the action time information of the user indicated by the user ID “0001” shown in FIG. 8, that the user has successfully bid for three kinds of products indicated by product IDs “A0001,” “C0201” and “T0211.” It can also be seen that the user bid for the product indicated by the product ID “A0001” at 21:55, 22:30 and 22:40 on Sunday, January 17. It can also be seen that the user used the auction service for 40 minutes from 22:10 of Saturday, January 16. In the example of FIG. 8, the evaluation value of the user is 12 points (“D”; the evaluation stage converted from the evaluation value).

The action time recording unit 73b records various histories of the user with reference to an event received by a service providing unit 53. When the event indicates login to the auction service or logout from the auction service, the action time recording unit 73b adds login date and time or logout date and time to the corresponding stay history of the action time information of the user. When the event indicates a successful bid of the product, the action time recording unit 73b adds the ID and the name of the product and the successful bid date and time to the corresponding successful bid history of the action time information of the user. When the event indicates a bid for the product, the action time recording unit 73b adds a record including the ID and the name of the product and a bid date and time to the corresponding bid history of the action time information of the user.

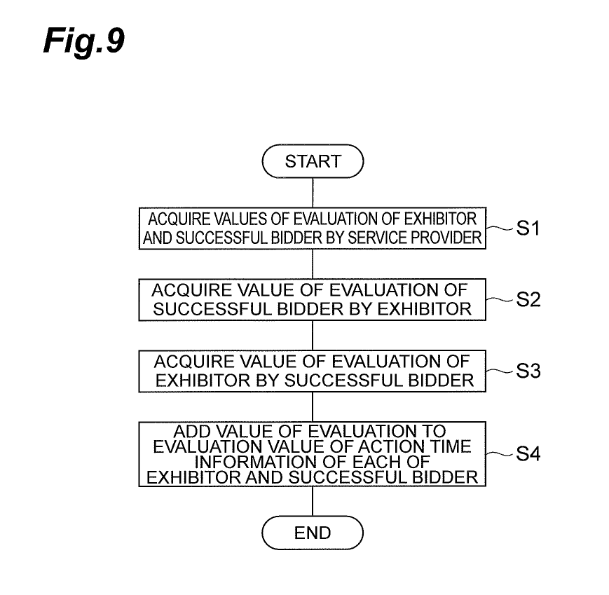

The evaluation value recording unit 73c updates the evaluation value of the user. As shown in FIG. 9, the evaluation value recording unit 73c acquires evaluation values of an exhibitor and a successful bidder set by a service provider, which provides the auction service using the server 11 (S1). In this case, the evaluation value recording unit 73c may acquire the evaluation values from a predetermined database of the service provider. The evaluation value recording unit 73c then acquires an evaluation value of the successful bidder set by the exhibitor (S2). Further, the evaluation value recording unit 73c acquires an evaluation value of the exhibitor set by the successful bidder (S3). In steps S2 and S3, the evaluation value recording unit 73c receives an evaluation value input by the user via a predetermined web page or receives an e-mail in which the evaluation value has been described by the user to acquire the evaluation value. The evaluation value recording unit 73c then adds the acquired evaluation value of the exhibitor or the successful bidder to the corresponding evaluation value of the action time information in the auction history database 57 to update the evaluation value of the person (S4).

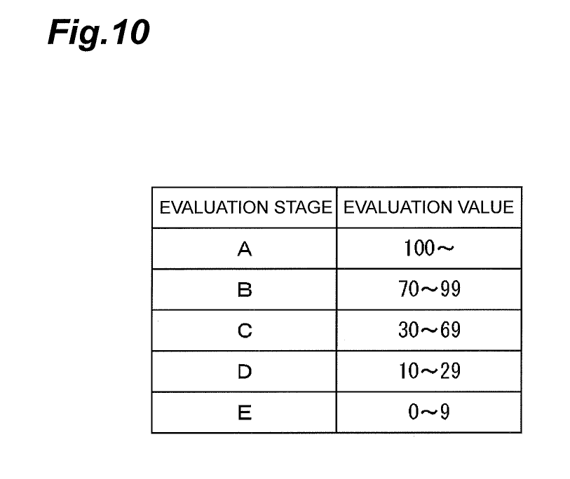

Further, the evaluation value recording unit 73c registers the evaluation stage corresponding to the updated evaluation value in the action time information with reference to a correspondence table of the evaluation value and the evaluation stage shown in FIG. 10. This correspondence table is held in the evaluation value recording unit 73c in advance.

The participant extraction unit 74c extracts the user ID (participant ID) of a user participating in the auction searched by the search unit 74a at a time point at which the exhibitor exhibits the product. The participant extraction unit 74c may extract various user IDs included in the auction information extracted by the search unit 74a as participant IDs. The type of participant ID extracted by the participant extraction unit 74c is not limited. For example, the participant extraction unit 74c may extract only the user ID of the bidder as the participant ID or may extract only the user ID of the bidder and the user ID of the user who registered the auction in a watch list as the participant IDs. The participant extraction unit 74c outputs the extracted participant ID to the estimation unit 75.

An estimation unit 75 estimates, as the prediction time period, a time period in which many bids are expected at the auction for the exhibition product and an end time of the auction hardly overlaps end times of other auctions, and transmit the prediction time period to the user terminal 13.

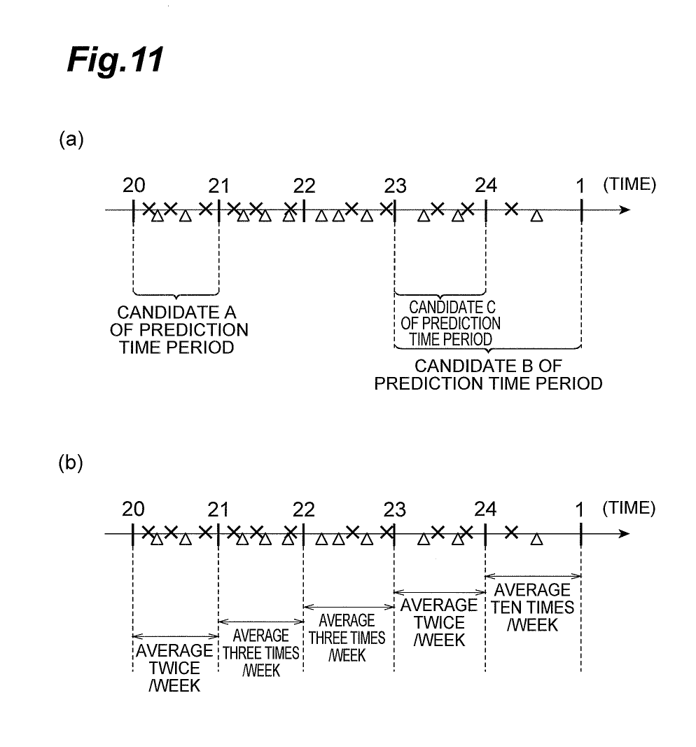

The estimation unit 75 estimates candidates of the prediction time period with reference to the end time of the auction and action time information in the auction history database 57. This estimation scheme will be described with reference to FIG. 11.

A triangle mark in FIG. 11 indicates an end time of another auction of which the end day is the same as the auction end day of the exhibition product. First, the estimation unit 75 identifies a time period in which the number of other auctions is equal to or more than a predetermined threshold, as in the example shown in FIG. 5. The estimation unit 75 then sets time periods other than the identified time period as candidate time periods. In the example of FIG. 11, if the threshold is 3, the estimation unit 75 sets time periods 20:00 to 21:00 (see candidate A of the prediction time period) and 23:00 to 1:00 (see candidate B of the prediction time period) as the candidate time periods.

Some schemes of determining the prediction time period from the candidate time periods may be considered. First, the estimation unit 75 may estimate the prediction time period based on the hourly number of participants of the auction. This scheme will be described with reference to FIG. 11(a). Further, in the example of FIG. 11(a), participants are limited to bidders to simplify a description. A mark x in FIG. 11(a) indicates a time when a bid was performed in auctions of other products belonging to the category of the exhibition product. In the example shown in FIG. 11(a), three persons make bids between 20:00 and 21:00, and three persons make bids between 21:00 and 22:00, two persons make bids between 22:00 and 23:00, three persons make bids between 23:00 and 0:00, and one person makes a bid between 0:00 and 1:00. The estimation unit 75 obtains the hourly number of participants as shown in FIG. 11 by totaling the bid history of the action time information.

The estimation unit 75 then estimates the prediction time period by filtering the candidate time periods based on the acquired hourly number of participants, from the candidate time periods estimated based on the end times of the auctions. In the example of FIG. 11(a), the estimation unit 75 selects, as the prediction time period, the time period “20:00 to 21:00” in which there are the most participants from among the candidate time periods. In this case, a condition “there are the most participants” is said to be the threshold. Further, the estimation unit 75 may set, as the candidate time period, a time period in which the number of participants is equal to or more than a predetermined threshold among the candidate time periods. For example, when the threshold is 2, the estimation unit 75 selects “20:00 to 21:00” and “23:00 to 24:00” in which there are two or more participants, as the prediction time periods. The predetermined threshold may be an absolute number of participants or may be a ratio of the number of participants to a total number of users logging into the auction in a predetermined time.

The estimation unit 75 may estimate the prediction time period based on a participation frequency of each user. This scheme will be described with reference to FIG. 11(b). Further, even in this example, participants are limited to bidders to simplify a description. A mark x in FIG. 11(b) also indicates a time when a bid was performed at another auction. As shown in the example of FIG. 11(b), an average bid frequency of three users making bids between 20:00 and 21:00 is twice a week, and an average bid frequency of three users making bids between 21:00 and 22:00 is three times a week. An average bid frequency is similarly shown for other time periods. The estimation unit 75 obtains the hourly average bid frequency as shown in FIG. 11(b) by totaling the bid history of the extracted action time information.

The estimation unit 75 then estimates the prediction time period based on the acquired hourly average bid frequency. In this case, the estimation unit 75 may perform weighting to multiply the number of bidders by an average bid frequency and set a time period in which a weighting result is highest as the candidate time period. For example, in the case of FIG. 11(b), the estimation unit 75 selects a time period “24:00 to 1:00” in which the weighting result is 1 times 10=10, as the prediction time period. Further, the estimation unit 75 may select a time period in which the average bid frequency is highest as the prediction time period. The bid frequency is considered in this way because a bid is estimated to be highly likely to be actively performed even in the auction of the exhibition product in a time period in which a user having a high bid frequency acts.

When there are a plurality of acquired candidate time periods, the estimation unit 75 may estimate the prediction time period from the candidate time periods with further reference to the evaluation value of each user. For example, the estimation unit 75 may select the candidate time period in which the number of participants whose evaluation value or evaluation stage is equal to or more than a predetermined threshold (hereinafter also referred to as a “high rater”) is greatest as the prediction time period. Further, the estimation unit 75 may select the candidate time period in which a ratio of the number of high raters to a total number of users logging into the auction in a predetermined time is highest as the prediction time period. Alternatively, the estimation unit 75 may select the candidate time period in which a ratio of the number of high raters to a total number of participants in a predetermined time is highest as a final prediction time period. Further, the estimation unit 75 may select the candidate time period in which a result of multiplying the number of participants by a weight set for each evaluation stage in advance is greatest as the prediction time period.

Further, a threshold of the evaluation value or the evaluation stage may be arbitrarily set. For example, 70 may be set as the threshold of the evaluation value or “B” may be set as the threshold of the evaluation stage.

The estimation unit 75 transmits the prediction time period estimated as described above to the user terminal 13 of the exhibitor.

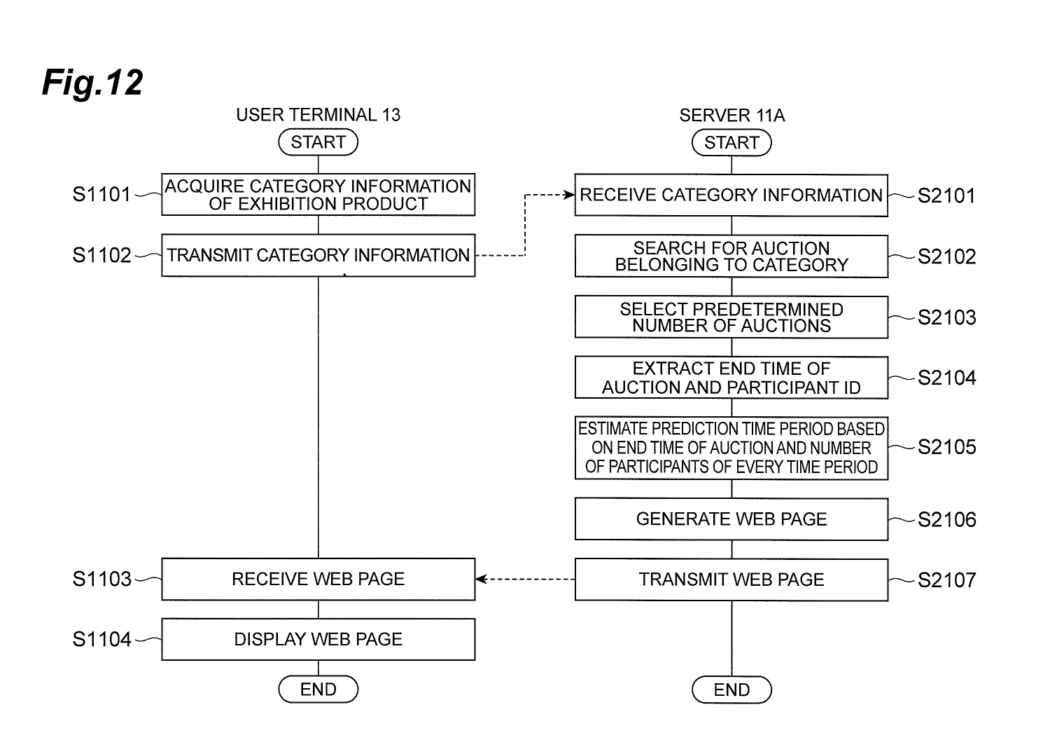

Next, a prediction time period estimation process (an information providing method) in the present embodiment will be described with reference to FIG. 12. A process of steps S1101, S1102, and S2101 to S2103 is the same as the process of steps S1001, S1002, and S2001 to S2003 in the first embodiment.

The end time extraction unit 74b then extracts an end time of the auction based on the auction information of the selected auction (S2104; identifying step). Further, the participant extraction unit 74c extracts the user ID (participant ID) of the participant in the auction based on the auction information (S2104).

The prediction time is then estimated by the estimation unit 75. Specifically, the estimation unit 75 identifies the candidate time period as in the first embodiment, and totals the hourly number of participants based on the action time information corresponding to the extracted participant ID. Further, the estimation unit 75 estimates the prediction time period based on the number of participants in each candidate time period (S2105; estimating step). Some prediction schemes in this case may be considered, as described above.

A process of subsequent steps S2106, S2107, S1103, and S1104 is similar to the process of steps S2006, S2007, S1003, and S1004 in the first embodiment.

As described above, according to the present embodiment, the time period in which participants the number of which is equal to or more than a certain number are expected and the end time hardly overlaps end times of the other auctions is estimated as the prediction time period. By providing this prediction time period to the exhibitor, the exhibitor can determine the end date and time in consideration of the prediction time period. In other words, it is possible to provide useful information for determining an auction end time to the exhibitor who wishes to determine the auction end time.

### Third Embodiment

Next, an information providing system according to a third embodiment will be described. This information providing system is the same as that in the second embodiment in that a prediction time period is estimated based on the action information, but is different from that in the second embodiment in a concrete procedure. Specifically, the prediction time period is estimated based on a participation situation of all auctions rather than a participation situation of auctions that are related to products in the same category as an exhibition product and currently accepting bids. Accordingly, the information providing system of the present embodiment includes a server 11B in place of the server 11A. Hereinafter, a description of matters that are the same as or equivalent to those in the first and second embodiments will be omitted.

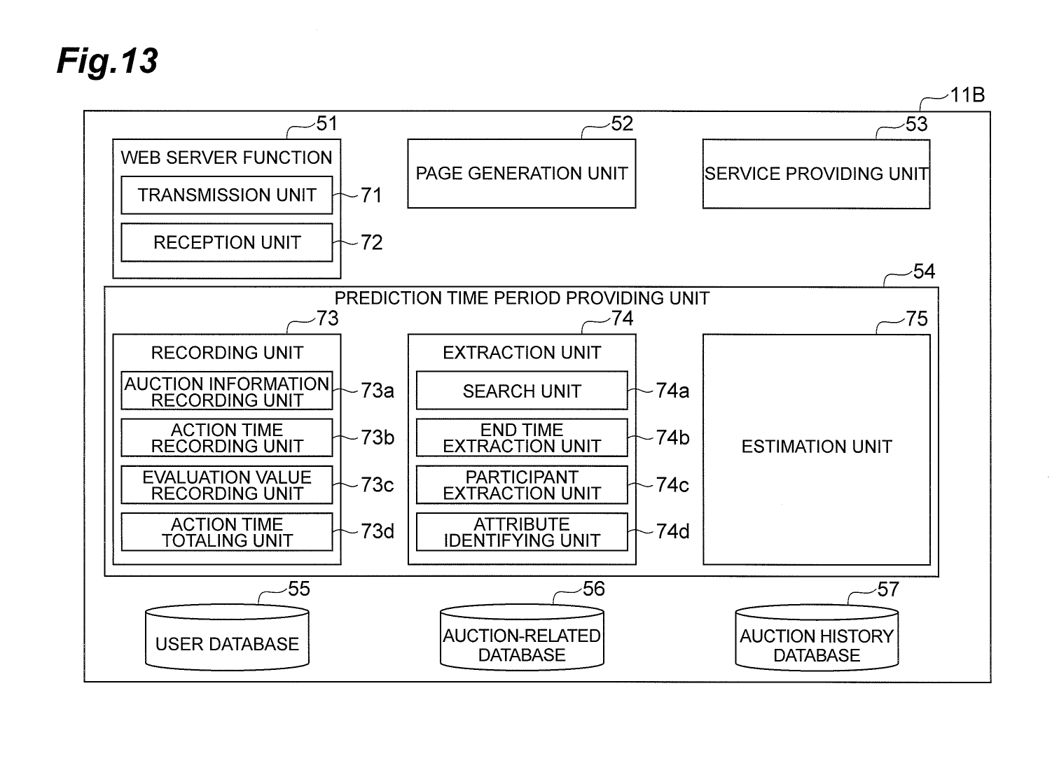

A functional configuration of the server 11B is shown in FIG. 13. The server 11B is different from the server 11A in that the server 11B further includes an action time totaling unit 73d in a recording unit 73 and further includes an attribute identifying unit 74d in an extraction unit 74. Further, in response thereto, operations of some functional components are also different from those in the first and second embodiments.

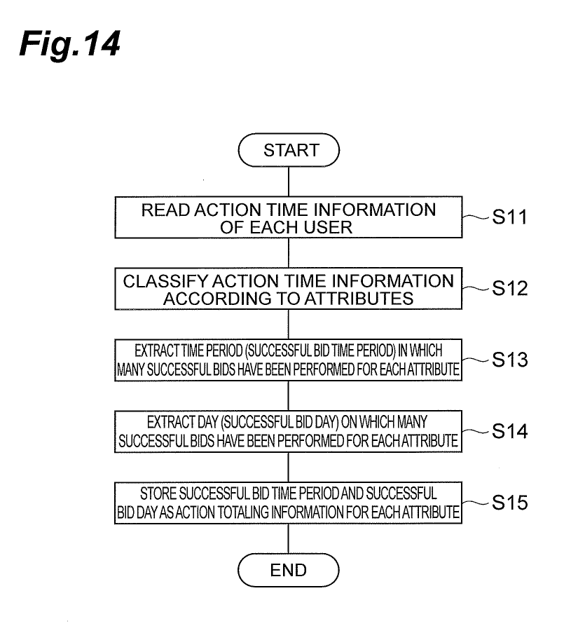

The action time totaling unit 73d starts up in a predetermined time and performs a process shown in FIG. 14. First, the action time totaling unit 73d reads action time information of each user from an auction history database 57 (S11) and classifies the action time information according to attributes (S12). A classification method is not limited. For example, the action time totaling unit 73d may classify the action time information according to an age group or sex or may classify the action time information according to the sex and the age group.

The action time totaling unit 73d then extracts, as a successful bid time period, a time period in which many successful bids have been performed for each attribute (S13). Some successful bid time period extracting methods may be considered. For example, the action time totaling unit 73d may extract a time period in which the number of successful bids is greatest for each attribute as the successful bid time period. In this case, a condition “the number of successful bids is greatest” is used as a threshold. Further, the action time totaling unit 73d may extract a time period in which the number of successful bids is equal to or more than a predetermined threshold (e.g., 10,000) for each attribute as the successful bid time period. Alternatively, the action time totaling unit 73d may extract, as the successful bid time period, a time period in which a ratio of the number of successful bids in a specific time period to the total number of successful bids in the attribute is equal to or more than a predetermined threshold (e.g., 30%) for each attribute.

The action time totaling unit 73d then extracts a day on which many successful bids have been performed for each attribute as a successful bid day (S14). Some methods of extracting a successful bid day may also be considered. For example, the action time totaling unit 73d may extract a day on which the number of successful bids is greatest for each attribute as a successful bid day. Further, the action time totaling unit 73d may extract a day on which the number of successful bids is equal to or more than a predetermined threshold (e.g., 30,000) for each attribute as the successful bid day. Alternatively, the action time totaling unit 73d may extract, as the successful bid day, a day on which a ratio of the successful bid number in a specific day to a total number of successful bids in the attribute is equal to or more than a predetermined threshold (e.g., 30%) for each attribute.

The action time totaling unit 73d then stores the successful bid time period and the successful bid day as action totaling information for each attribute in the auction history database 57 (S15). Further, a storage place for the action totaling information is not limited to this example.

Further, the action time totaling unit 73d may generate the action totaling information for each category of a product exhibited for an auction and for each attribute of a participant, and store the action totaling information in the auction history database 57. In this case, the action time totaling unit 73d classifies the action time information extracted from the auction history database 57 according to the category and each attribute of the participant. The action time totaling unit 73d then extracts a time period when many successful bids have been performed for each category and each attribute as the successful bid time period.

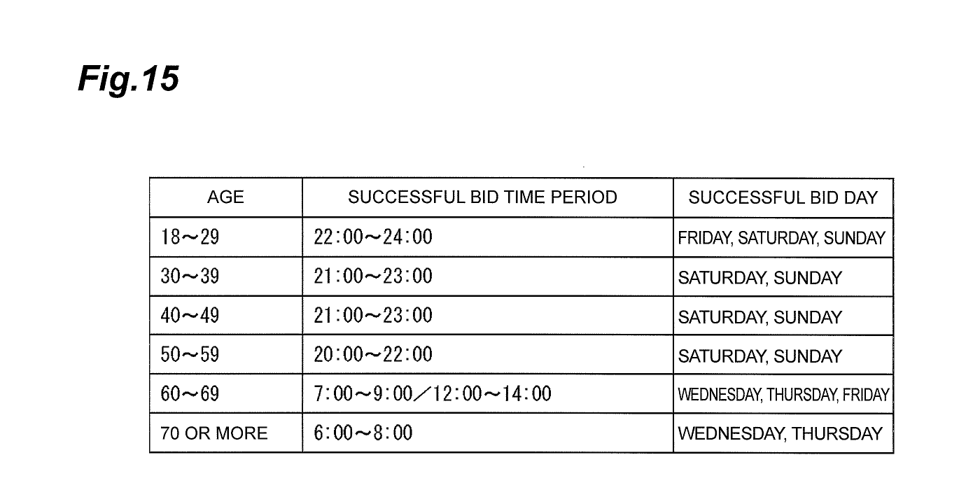

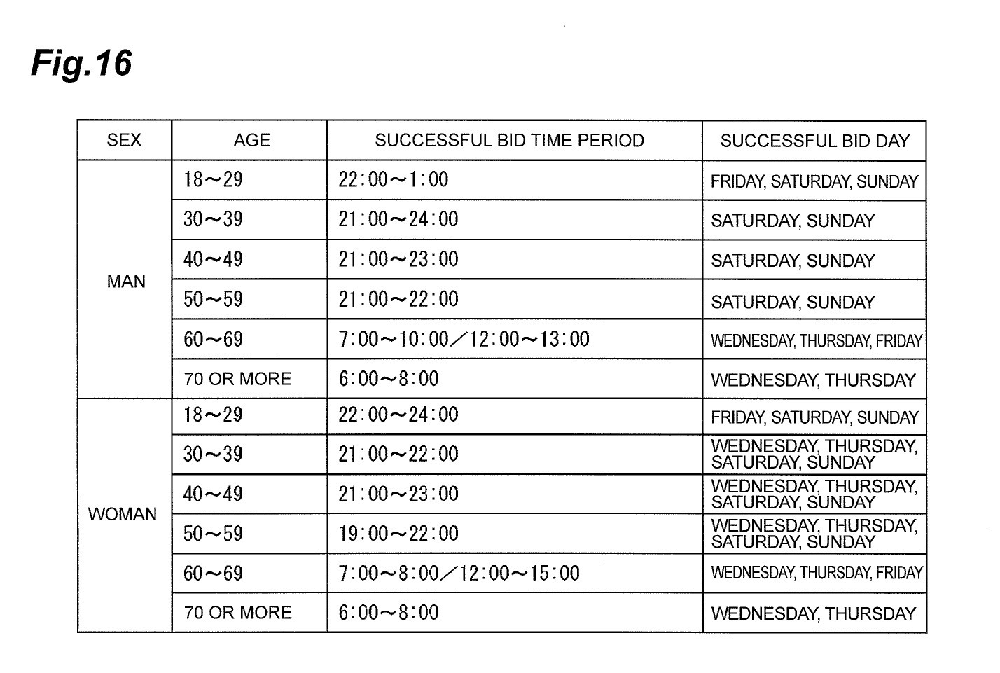

Examples of the action totaling information are shown in FIGS. 15 and 16. The action totaling information shown in FIG. 15 is action totaling information when totaling is performed according to the age group. For example, it can be seen, from this action totaling information, that users belonging to the age group of 18 to 29 have a great tendency to make successful bids between 22:00 and 24:00 and also on Fridays, Saturdays and Sundays. On the other hand, the action totaling information shown in FIG. 16 is action totaling information when totaling is performed according to the sex and the age group. Further, setting of the age group and setting of the time are not limited to the examples of FIGS. 15 and 16 and may be arbitrarily determined. For example, the action time totaling unit 73d may set a width of the age group to 5 (years) and may total the number of successful bids hourly. When a plurality of attributes are added as in the example of FIG. 16, the prediction time period can be estimated in greater detail. When the action totaling information is generated according to the category of the product and the attribute of the participant, the totaling results as shown in FIGS. 15 and 16 are obtained for each category of the product.

Return to FIG. 13, the attribute identifying unit 74d extracts, from the auction history database 57, action time information corresponding to a participant ID extracted by a participant extraction unit 74c, and identifies attributes of the participant based on the action time information. Accordingly, the attribute identifying unit 74d acquires attributes of users who have participated in auctions of other products whose category is the same as that of the exhibition product. Further, the type of attribute identified herein is the same as the type of attribute processed in the action time totaling unit 73d. It is understood that the attribute identifying unit 74d may acquire a plurality of attribute values for one type of attribute. For example, the attribute identifying unit 74d may acquire two attribute values of “30 to 39” and “40 to 49” for the age group. The attribute identifying unit 74d outputs information of the acquired attributes to an estimation unit 75. The estimation unit 75 estimates a time period in which many bids are expected in the auction for the exhibition product and the end time hardly overlaps end times of the other auctions as the prediction time period, and transmits the prediction time period to the user terminal 13.

The estimation unit 75 estimates candidates of the prediction time period with reference to the auction information in the auction-related database 56 and the action time information or the action totaling information in the auction history database 57.

First, the estimation unit 75 estimates the candidate time periods based on the end time of the auction, as in the first and second embodiments. The estimation unit 75 then determines the prediction time period from the candidate time periods. Some determination methods may be considered, as shown below.

As a first method, the estimation unit 75 may estimate the prediction time period from the candidate time periods using only the action totaling information. First, the estimation unit 75 reads, from the auction history database 57, the action totaling information corresponding to the attribute of the participant input from the attribute identifying unit 74d. The estimation unit 75 then estimates a time and a day on which many bids are expected to be performed in the auction based on the successful bid time period and the successful bid day for each attribute indicated by the action totaling information.

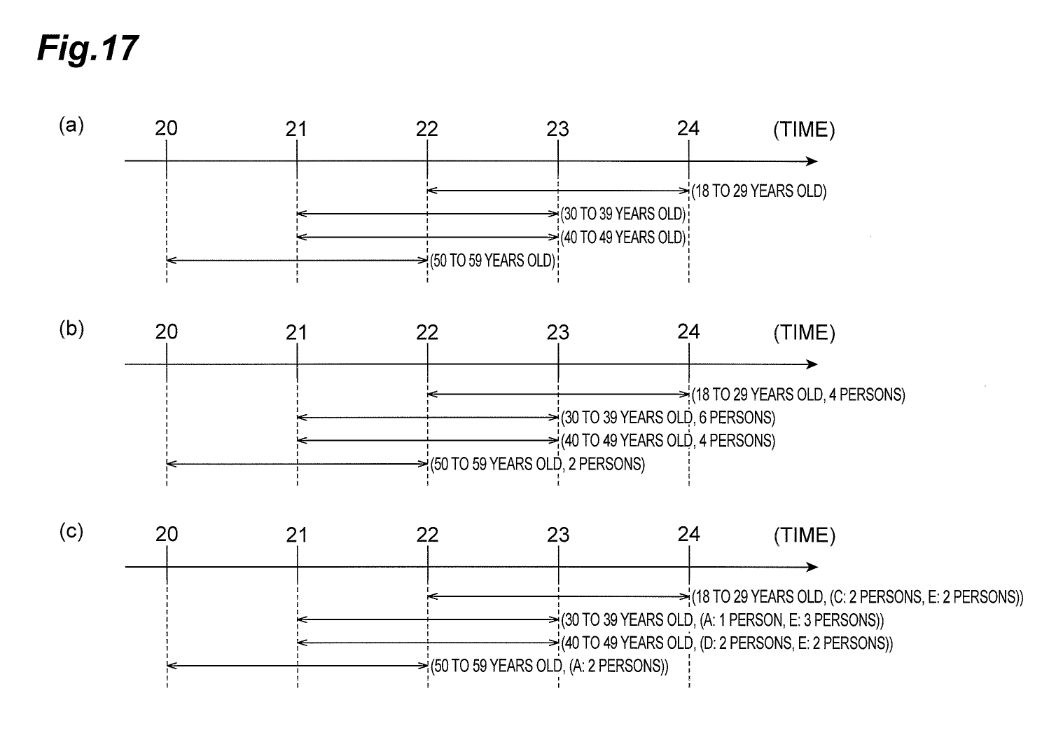

For example, the estimation unit 75 is assumed to have estimated the time period “20:00 to 24:00” as the candidate time period based on the end times of the auctions. Further, four age groups “18 to 29,” “30 to 39,” “40 to 49” and “50 to 59” in the action totaling information shown in FIG. 15 are assumed to be input from the attribute identifying unit 74d. In this case, the estimation unit 75 estimates a successful bid time period “22:00 to 24:00” of the age group “18 to 29,” a successful bid time period “21:00 to 23:00” of the age group “30 to 39,” a successful bid time period “21:00 to 23:00” of the age group “40 to 49” and a successful bid time period “20:00 to 22:00” of the age group “50 to 59” as the prediction time periods (see FIG. 17(a)). Further, the estimation unit 75 estimates the successful bid day corresponding to the input attribute (e.g., the age group) as the prediction time period. A process for the successful bid day is the same as the above process for a successful bid time period.

As a second method, the estimation unit 75 may estimate the prediction time period from the estimated candidate time periods using the action totaling information and the action time information. The estimation unit 75 is assumed to estimate the time period “20:00 to 24:00” as the candidate time period based on the end times of the auctions, as in the first method described above. In this case, first, the estimation unit 75 acquires the successful bid time period for each attribute, as in the first method described above. The estimation unit 75 then extracts, from the auction history database 57, the action time information in which the attributes coincide with each other and the bid date and time correspond to the successful bid time period, for each group of attributes and successful bid time period. The estimation unit 75 then obtains the number of bidders for each attribute and each successful bid time period based on the extracted action time information.

For example, the numbers of bidders corresponding to the successful bid time period of the age groups “18 to 29,” “30 to 39,” “40 to 49” and “50 to 59” are assumed to be 4, 6, 4, and 2, respectively, as shown in FIG. 17(b). In this case, the estimation unit 75 selects “22:00 to 23:00” in which the total number of bidders is greatest as the prediction time period.

Further, the estimation unit 75 estimates, as the candidate time period, a day on which the total number of bidders is greatest among the successful bid days corresponding to the input attribute (e.g., an age group). A process for a successful bid day is the same as the above process for a successful bid time period.

Further, the estimation unit 75 may total the number of bidders for each day and each time, and estimate, as the prediction time period, a specific time period on a specific day when the number is greatest.

Further, the estimation unit 75 may hold the prediction time period for each attribute shown in FIG. 17(b) together with the number of bidders corresponding to the prediction time period. In this case, the number of bidders in each prediction time period is also displayed in the web page to be provided to the exhibitor.

In this case, the number of persons may be indicated in each evaluation stage (evaluation value) as shown in FIG. 17(c). Accordingly, the exhibitor can select a time period in which a product is highly likely to be successfully bid for by a high rater. For example, in the example of FIG. 17(c), the exhibitor can determine the end time within a time period from 21:00 to 22:00 in which a product is highly likely to be successfully bid for by users having evaluation stage “A.”

Further, if it is most preferential that the product is successfully bid for by a bidder having a higher evaluation value, the estimation unit 75 may extract a time period from 20:00 to 21:00 in which only users of evaluation stage “A” are shown in the example of FIG. 17(c).

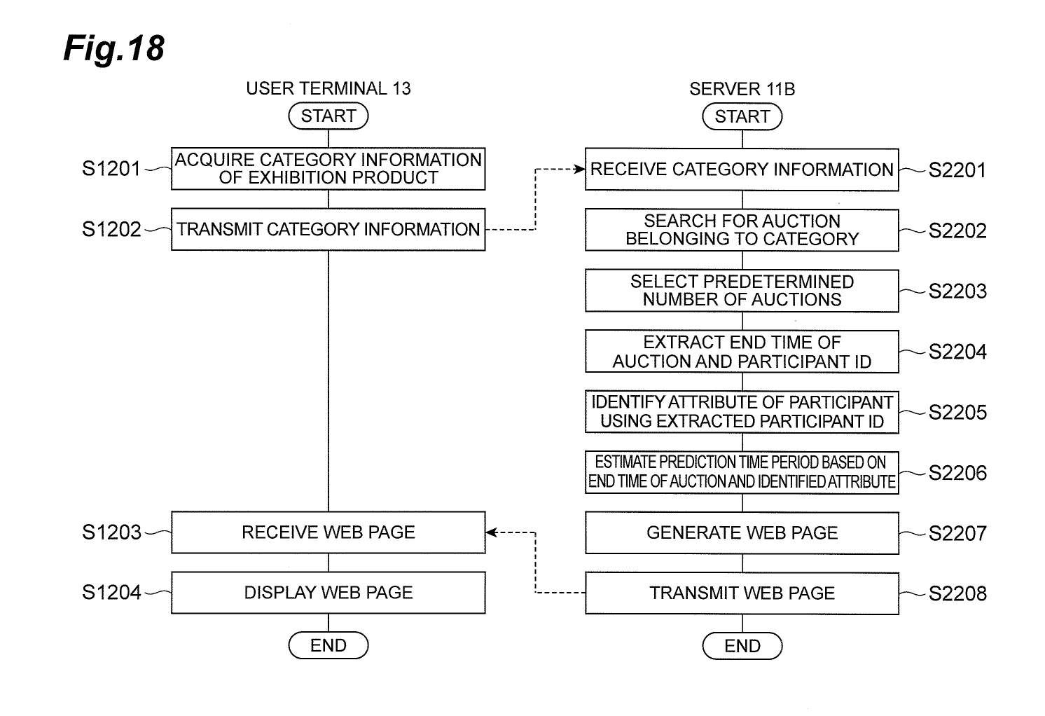

Next, a prediction time period estimation process (an information providing method) in the present embodiment will be described with reference to FIG. 18. A process of steps S1201, S1202, and S2201 to S2204 is the same as the process of step S1101, S1102, and S2101 to S2104 in the second embodiment.

The attribute identifying unit 74d then extracts the action time information corresponding to the extracted participant ID from the auction history database 57 and identifies the attribute of the participant based on the action time information (S2205; identifying step).

The estimation unit 75 then estimates the prediction time period. Specifically, the estimation unit 75 identifies candidate time periods and extracts the action totaling information or the action time information corresponding to the extracted attribute of the participant from the auction history database 57, as in the first and second embodiments. Further, the estimation unit 75 estimates the prediction time period based on the action totaling information or the action time information corresponding to each candidate time period (S2205; estimating step).

A process of subsequent steps S2207, S2208, S1203, and S1204 is the same as the process of steps S2106, S2107, S1103 and S1104 in the second embodiment.

As described above, according to the present embodiment, the time period in which participants the number of which is equal to more than a certain number are expected and the end time hardly overlaps end times of the other auctions is estimated as the prediction time period. By providing this prediction time period to the exhibitor, the exhibitor can determine the end date and time in consideration of the prediction time period. In other words, it is possible to provide useful information for determining an auction end time to the exhibitor who wishes to determine the auction end time.

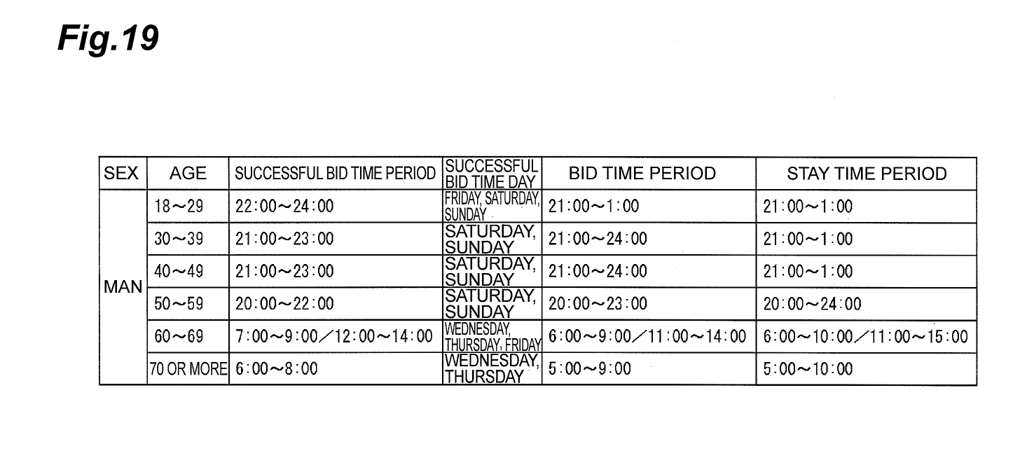

Further, action totaling information as shown in FIG. 19 may be used in the present embodiment. In other words, the action time totaling unit 73d may calculate the successful bid time period and the successful bid day, as well as a time period (bid time period) in which the number of bids is greatest and a time period (stay time period) in which the number of the stays of the user is greatest according to the sex and the age group to generate the action totaling information including such information. While only the action totaling information for men is shown in FIG. 19, action totaling information for women may be similarly generated. When the action totaling information is generated according to the category of the product and the attribute of the participants, the totaling result as shown in FIG. 19 may be obtained for each category of the product.

In this case, the estimation unit 75 extracts the successful bid time period, the successful bid day, a bid time period, and a stay time period for each attribute based on the action totaling information. The estimation unit 75 then estimates the prediction time period from the candidate time periods based on the extracted information and the attribute of each participant extracted using the participant ID.

### Fourth Embodiment

Next, an information providing system according to a fourth embodiment will be described. This information providing system is different from the information providing systems according to the second and third embodiments in that a method of processing a prediction time period is selected based on an exhibition period of a product designated by an exhibitor. Accordingly, the information providing system of the present embodiment includes a server 11C in place of the servers 11A and 11B. Hereinafter, a description of matters that are the same as or equivalent to those in the second and third embodiments will be omitted.

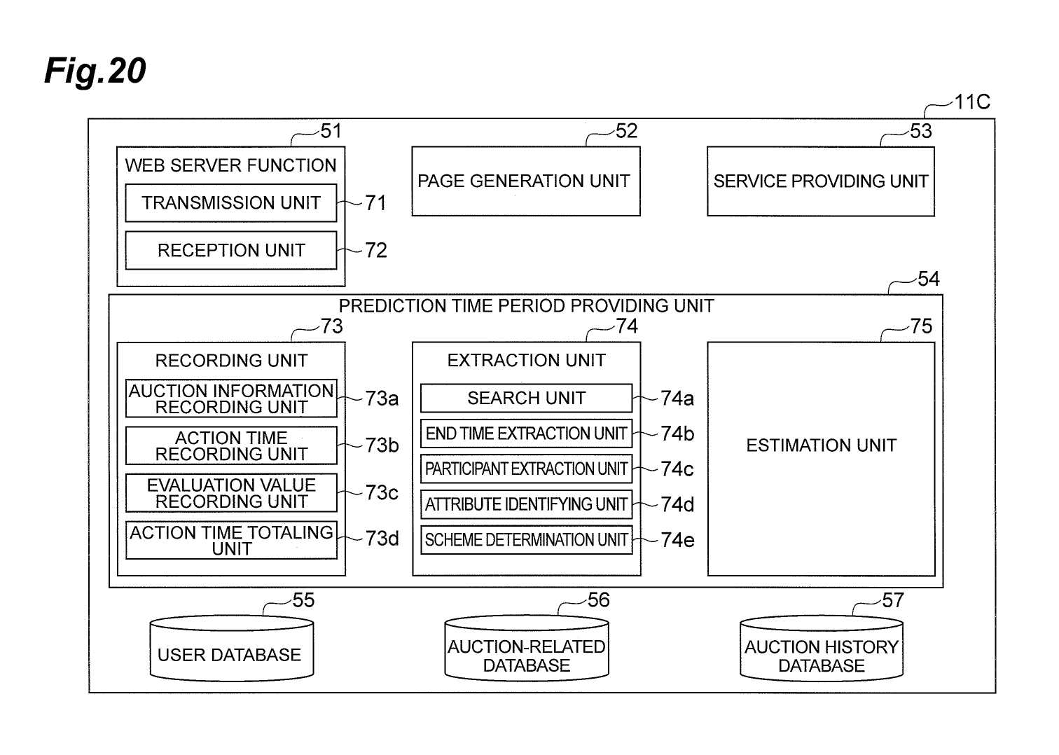

A functional configuration of the server 11C is shown in FIG. 20. The server 11C is different from the server 11B in that a scheme determination unit 74e is further included in an extraction unit 74.

The scheme determination unit 74e acquires an exhibition period transmitted from the user terminal 13 of the exhibitor and determines a prediction time period estimation method based on the exhibition period. When the exhibition period is shorter than a predetermined period (e.g., a week), the scheme determination unit 74e determines to estimate the prediction time period using the same scheme as that in the second embodiment. When the exhibition period is equal to or more than the predetermined period, the scheme determination unit 74e determines to estimate the prediction time period using the same scheme as that in the third embodiment. Based on this determination, the extraction unit 74 and the estimation unit 75 estimate the prediction time period using either the scheme of the second embodiment or the scheme of the third embodiment.

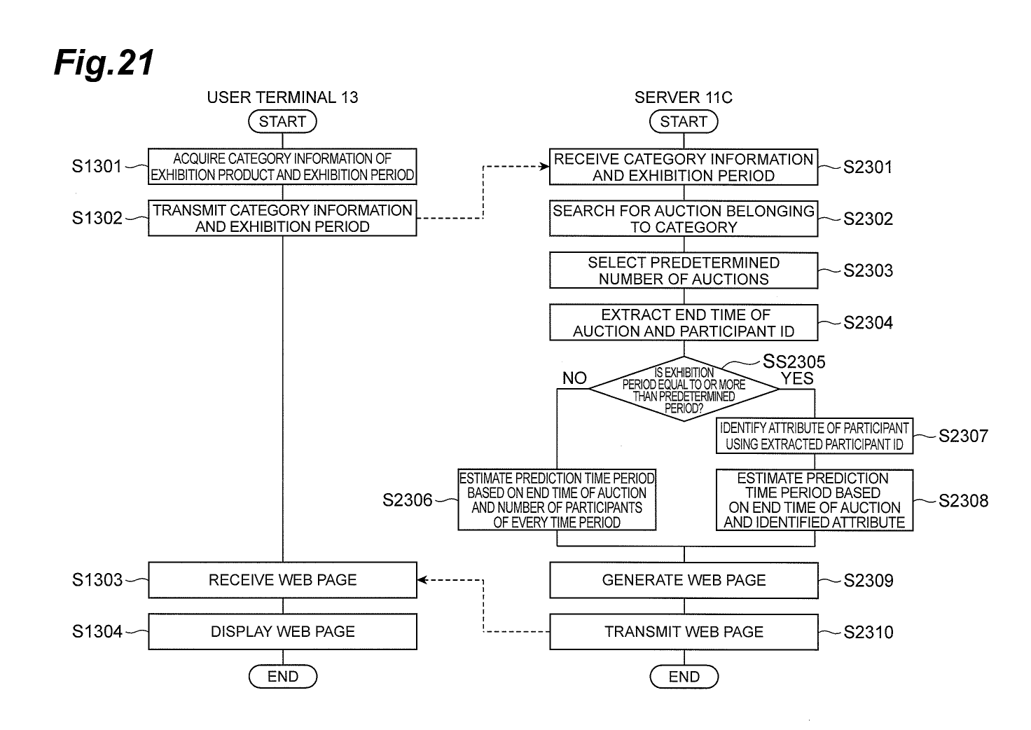

A prediction time period estimation process (an information providing method) in the present embodiment will be described with reference to FIG. 21. First, the user terminal 13 acquires a category and an exhibition period of an exhibition product input by the exhibitor (S1301). The exhibition period is acquired by the exhibitor inputting an end date and time in a web page in which exhibition for auction is received. The user terminal 13 then transmits the acquired category information and the exhibition period to the server 11C (S1302).

In the server 11C, a reception unit 72 of a web server function 51 receives the category information and the exhibition period (S2301). A process of subsequent steps S2302 to S2304 is the same as the process of steps S2102 to S2104 in the second embodiment.

The scheme determination unit 74e then determines whether the exhibition period is equal to or more than a predetermined period (S2305; estimating step). When the exhibition period is shorter than the predetermined period (S2305; NO), the prediction time period is estimated based on the end time of an auction and the hourly number of participants, as in the process of step S2105 in the second embodiment (S2306; estimating step). On the other hand, when the exhibition period is equal to or more than the predetermined period (S2305; YES), the attribute of the participant is identified from the extracted participant ID (S2307; estimating step) and the prediction time period is estimated based on the end time of the auction and the attribute (S2308; estimating step), as in the procedure of S2205 and S2206 in the third embodiment. A process of subsequent steps S2309, S2310, S1303, and S1304 is the same as the process of steps S2106, S2107, S1103 and S1104 in the second embodiment.

As described above, according to the present embodiment, when the exhibition period of the product is shorter than the predetermined period, the hourly number of participants is considered, and a time period in which participants the number of which is equal to or more than a certain number are expected is estimated as the prediction time period. On the other hand, when the exhibition period is equal to or more than the predetermined period, the attribute of the participant is identified from the action time information, and a time period in which participants the number of which is equal to or more than a certain number are expected and the end time hardly overlap the end times of other auctions is estimated as the prediction time period based on the attribute. In other words, it is possible to provide useful information for determining an auction end time to the exhibitor who wishes to determine the auction end time.

When the exhibition period is short, the identified participant himself or herself tends to participate in the auction. On the other hand, when the exhibition period is long, a general participation tendency of a user having the same attribute as the identified participant often corresponds to a participation tendency in a specific auction. Accordingly, it is effective to change the prediction time period estimation method according to a length of the exhibition period, as described above.

### Fifth Embodiment

Next, an information providing system according to a fifth embodiment will be described. This information providing system is different from the information providing system according to the second embodiment in that the prediction time period is estimated based on a ratio of the number of accesses, of every predetermined time period, to an auction calculated from the action time information and the number of auctions that end in the predetermined time period. Accordingly, the information providing system of the present embodiment includes a server 11D in place of the server 11A. Hereinafter, description of matters that are the same as or equivalent to those in the second embodiment will be omitted.

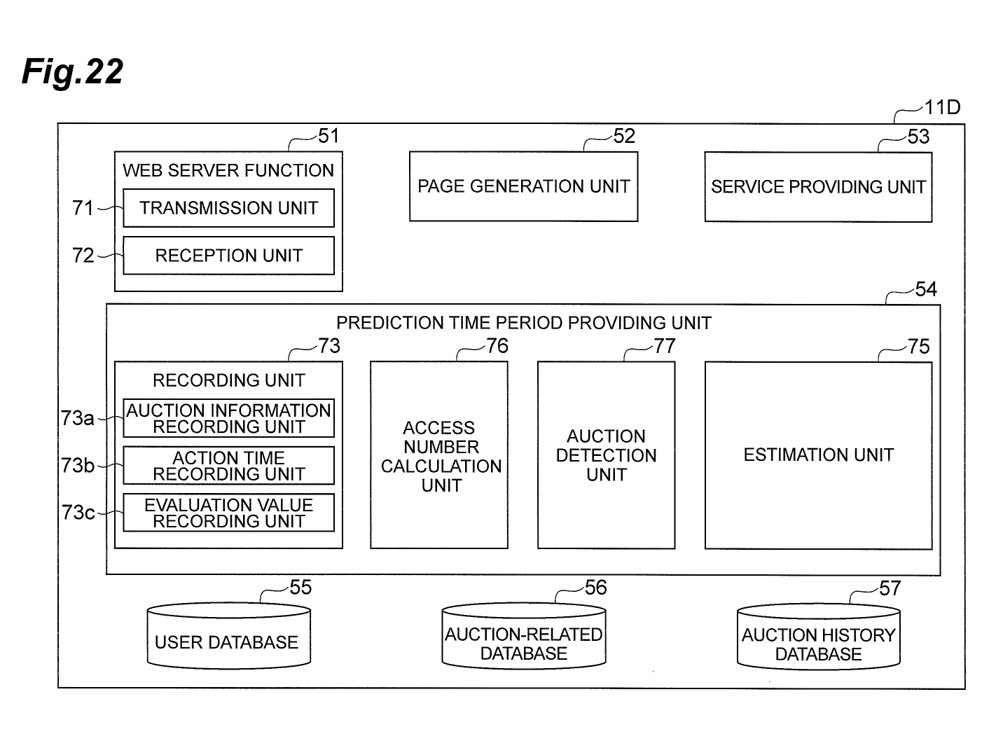

A functional configuration of the server 11D is shown in FIG. 22. The server 11D is different from the server 11A in that the server 11D includes an access number calculation unit 76 and an auction detection unit 77 in place of the extraction unit 74. Further, in response thereto, operations of some functional components are also different from those in the second embodiment.

The access number calculation unit 76 (access number calculation means) calculates the number of accesses, of every predetermined time period, to a plurality of other auctions belonging to a category of an exhibition product. The access number calculation unit 76 acquires category information indicating the category of the exhibition product, which is transmitted from the user terminal 13 of the exhibitor. The access number calculation unit 76 then extracts auction information corresponding to a plurality of other auctions belonging to the category indicated by the category information from an auction-related database 56. The access number calculation unit 76 then totals the number of accesses of participants of the extracted auction every predetermined time period with reference to the action time information stored in an auction history database 57. The access number calculation unit 76 outputs the totaled number of accesses of every predetermined time to an estimation unit 75.

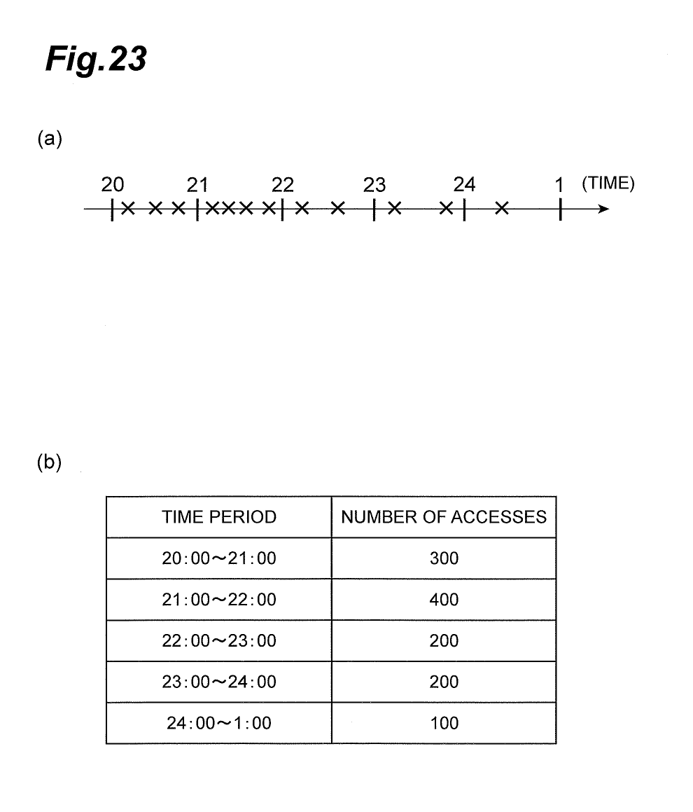

An example of calculation of the number of accesses in the access number calculation unit 76 will be described with reference to FIG. 23. Mark x in FIG. 23(a) indicates a time when access to other auctions belonging to the category of the exhibition product was performed. Here, one x in FIG. 23(a) indicates that there were 100 accesses to other auctions. As shown in the example shown in FIG. 23(a), 300 accesses were performed between 20:00 and 21:00, and 400 accesses were performed between 21:00 and 22:00. The same is also considered for other time periods.

The access number calculation unit 76 calculates, for example, the number of accesses to the other auctions hourly as shown in FIG. 23(b) by totaling the action history extracted from the action time information.

The auction detection unit 77 (auction detection means) extracts end dates and times of other auctions that belong to the category of the exhibition product and are currently held to calculate the number of auctions that end every predetermined time period. The auction detection unit 77 extracts, from the auction-related database 56, auction information corresponding to the other auctions (other auctions being held), which belong to the category indicated by the category information transmitted from the user terminal 13 of the exhibitor and currently accept bids. The auction detection unit 77 totals the number of auctions that end every predetermined time period with reference to the end date and time of the extracted auction information. The auction detection unit 77 outputs the totaled hourly number of the ended auctions to the estimation unit 75.

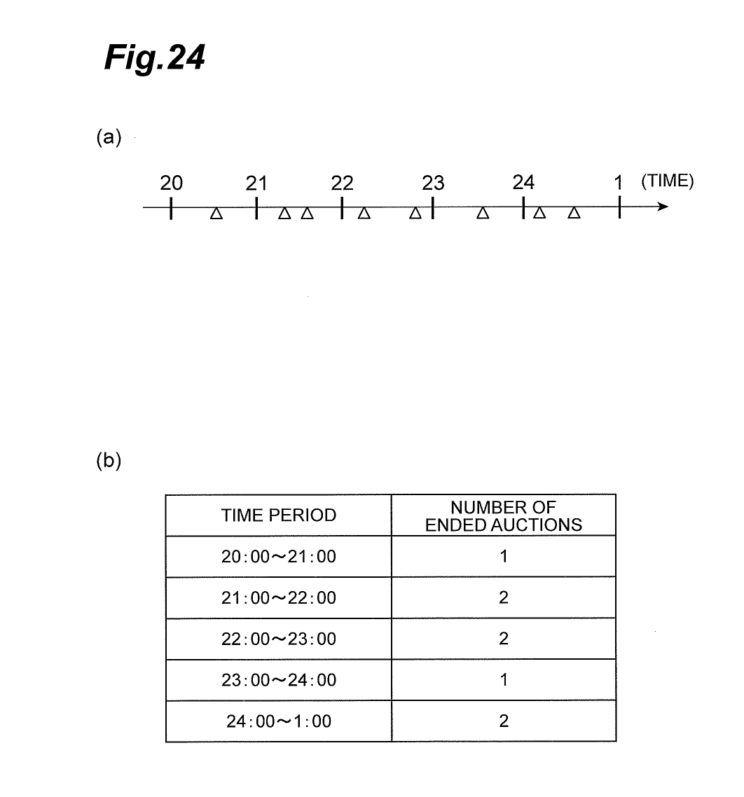

An example of calculation of the number of ended auctions in the auction detection unit 77 will be described with reference to FIG. 24. A triangle mark in FIG. 24(a) indicates an end date and time of an auction that belongs to the category of the exhibition product and currently accepts bids. In the example shown in FIG. 24(a), the end time is set at one auction from 20:00 to 21:00, and the end time is set at two auctions from 21:00 to 22:00. The same is also considered for other time periods.

The auction detection unit 77 calculates, for example, the number of ended auctions hourly as shown in FIG. 24(b) by totaling the extracted auction information.

The estimation unit 75 (auction holding period identifying means) estimates, as the prediction time period (auction holding period), a time period in which the number of accesses to the other auctions belonging to the category of the exhibition product is great and the end date and time hardly overlaps end dates and times of the other held auctions belonging to the category of the exhibition product. The estimation unit 75 outputs the prediction time period to the user terminal 13.

Specifically, the estimation unit 75 calculates a ratio of the number of ended auctions detected by the auction detection unit 77 to the number of accesses to the auctions calculated by the access number calculation unit 76 every predetermined time period. Further, the estimation unit 75 determines a time period in which the ratio is smallest as the prediction time period. In other words, the estimation unit 75 estimates, as the prediction time period, a time period in which the number of ended auctions is smaller relative to the number of accesses. Further, the estimation unit 75 outputs the determined prediction time period to a page generation unit 52.

When the hourly number of accesses and the hourly number of the ended auctions are obtained as shown in FIGS. 23(b) and 24(b), the ratio of the number of ended auctions to the number of accesses is 1/300 from 20:00 to 21:00, 1/200 from 21:00 to 22:00, 1/100 from 22:00 to 23:00, 1/200 from 23:00 to 24:00, and 1/50 from 24:00 to 1:00. Accordingly, the estimation unit 75 estimates, as a candidate time period, the time period “20:00 to 21:00” in which the ratio of the number of auctions that end in the time period to the number of accesses to the auction is smallest.

The estimation unit 75 may set, as the candidate time period, a time period in which the ratio of the number of ended auctions to the number of accesses to the auction is equal to or less than a predetermined threshold. In the example of FIGS. 23(b) and 24(b), for example, when the threshold is 1/200, the estimation unit 75 estimates “20:00 to 21:00,” “21:00 to 22:00,” and “23:00 to 24:00” as the candidate time periods.

The estimation unit 75 may output one or more candidate time periods as one or more prediction time periods to the page generation unit 52. Alternatively, the estimation unit 75 may set a time period from a current time point to the candidate time period as the prediction time period. When there are a plurality of candidate time periods, the estimation unit 75 may sort the candidate time periods using the following method and output the candidate time periods to the page generation unit 52. For example, the estimation unit 75 may sort the candidate time periods in an order by which the ratio of the number of ended auctions to the number of accesses to the auction is smaller. Through such a process, the prediction time period in which the number of ended auctions is smaller relative to the number of accesses is preferentially presented to the exhibitor.

When there are a plurality of candidate time periods, the estimation unit 75 may estimate the prediction time period from the candidate time periods with further reference to evaluation values of participant of past other auctions. For example, the estimation unit 75 may set the candidate time period in which the number of participants (high raters) whose evaluation value or evaluation stage is equal to or more than a predetermined threshold is greatest, as the prediction time period. Alternatively, the estimation unit 75 may set the candidate time period in which a ratio of the number of high raters to a total number of participants is highest as a final prediction time period.

The estimation unit 75 transmits the prediction time period estimated as described above to the user terminal 13 of the exhibitor.

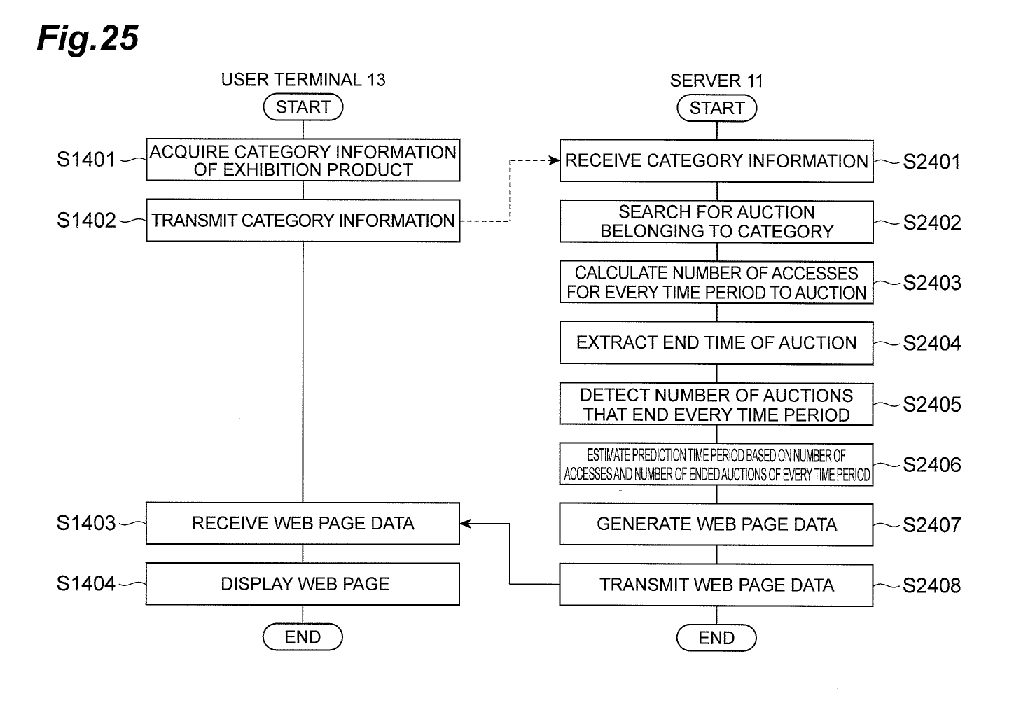

Next, a process of estimating a prediction time period (an information providing method) in the present embodiment will be described with reference to FIG. 25. A process of steps S1401, S1402, S2401, and S2402 is the same as the process of steps S1001, S1002, S2001, and S2002 in the first embodiment.

The access number calculation unit 76 then calculates the number of accesses, of every predetermined time, to past auctions of other products belonging to the category of the exhibition product based on the action time information corresponding to the searched auction (S2403; access number calculating step).

Next, the auction detection unit 77 extracts end dates and times of a plurality of other auctions based on the auction information corresponding to the plurality of other auctions belonging to the category of the exhibition product (S2404; auction detecting step). Further, the auction detection unit 77 detects the number of ended auctions every predetermined time (S2405; auction detecting step).

A prediction time period is then estimated by the estimation unit 75. Specifically, the estimation unit 75 estimates a time period in which a ratio of the number of ended auctions detected by the auction detection unit 77 to the number of accesses to the other auctions calculated by the access number calculation unit 76 is small, as the prediction time period. In other words, the estimation unit 75 estimates a time period in which the number of ended auctions is smaller relative to the number of accesses, as the prediction time period (S2406; auction holding period identifying step).

A process of subsequent steps S2407, S2408, S1403, and S1404 is the same as the process of steps S2006, S2007, S1003, and S1004 in the first embodiment.

As described above, according to the present embodiment, the prediction time period is estimated based on the ratio of the number of accesses to past other auctions and the number of ends of other held auctions. Accordingly, the time period in which many accesses to the auction of the exhibition product are expected and the end time hardly overlaps end times of other auctions is estimated as an auction holding period. By providing this auction holding period to the exhibitor, the exhibitor can determine the end date and time in consideration of the prediction time period. In other words, it is possible to provide useful information for determining an end time of an auction holding period to the exhibitor who wishes to determine the auction holding period.

The present invention has been described above based on the embodiments in detail. However, the present invention is not limited to the embodiments described above. Various modifications may be made to the present invention without departing from the scope and spirit of the present invention.

In each embodiment described above, while the extraction unit 74 extracts the auctions in which other products belonging to the category of the exhibition product have been exhibited, the extraction unit 74 may extract only auctions of the same product as the exhibition product.

In the respective embodiments described above, while the servers 11, 11A, 11B, 11C and 11D include the various databases 55, 56 and 57, the databases 55, 56, and 57 may be provided outside each server. In this case, the server may access the databases 55, 56, and 57 via a predetermined communication network. Similarly, the web server function 51, the page generation unit 52 and the service providing unit 53 may be arranged in a server other than the servers 11, 11A, 11B, 11C and 11D.

While three kinds of action histories (the bid history, the successful bid history, and the stay history) are included in the action time information in the second to fifth embodiments described above, only one or two kinds of the histories may be included in the action time information. Further, the action history included in the action time information is not limited to that described above and may be arbitrarily determined.

In the second to fifth embodiments described above, while the evaluation value is included in the action time information, such user evaluation information may be omitted. In relation to this, when the prediction time period is estimated, the evaluation value may not be used. Further, the estimation unit 75 may estimate the prediction time period using only one of the evaluation value and the evaluation stage.

In the second to fourth embodiments described above, the candidate time periods are extracted based on the attributes of the participants and the prediction time period is estimated based on the candidate time periods. However, when the action totaling information is generated according to the category of the product and the attribute of the participant, the candidate time periods may be extracted based on the attribute indicated by the action totaling information corresponding to the category of the exhibition product, and the prediction time period may be estimated based on the candidate time periods.

### REFERENCE SIGNS LIST

11, 11A, 11B, 11C, 11D . . . Server (information providing device), 12 . . . Internet, 13 . . . User terminal, 51 . . . Web server function, 52 . . . Page generation unit, 53 . . . Service providing unit, 54 . . . Prediction time providing unit, 55 . . . User database, 56 . . . Auction-related database (storage means), 57 . . . Auction history database (storage means), 71 . . . Transmission unit, 72 . . . Reception unit, 73 . . . Recording unit, 73a . . . Auction information recording unit, 73b . . . Action time recording unit, 73c . . . Evaluation value recording unit, 73d . . . Action time totaling unit, 74 . . . Extraction unit, 74a . . . Search unit, 74b . . . End time extraction unit, 74c . . . Participant extraction unit, 74d . . . Attribute identifying unit, 74e . . . Scheme determination unit, 75 . . . Estimation unit (auction holding period identifying means), 76 . . . Access number calculation unit (access number calculation means), 77 . . . Auction detection unit (auction detection means).

1.-7. (canceled)

8. An information providing device comprising:
an auction holding period identifying means that obtains the number of participants to past auctions of every predetermined time period for other products belonging to a category of a product that an exhibitor wishes to exhibit for an auction, based on action date and time information corresponding to the past auctions of the other products with reference to a storage means that stores the action date and time information indicating dates and times when participants have accessed the past auctions of the other products, and
identifies an auction holding period of the exhibitor based on the number of participants for every predetermined time period a participation frequency of the participants in the past auctions of the every predetermined time period collected from the action date and time information; and
a providing means that provides the auction holding period identified by the auction holding period identifying means to a terminal of the exhibitor.

9. The information providing device according to claim 8, wherein the auction holding period identifying means collects a mean participation frequency of the participants to the past auctions from the action date and time information, and identifies, as the auction holding period, a time period with a greatest value obtained by multiplying the mean participation frequency by the number of participants.

10. The information providing device according to claim 8, wherein:
the action date and time information further includes user evaluation information indicating evaluation of participants, and
when there are a plurality of auction holding periods, the providing means gives a priority to the plurality of auction holding periods based on evaluation of the participants with reference to the user evaluation information of the participants who accessed the past auctions.

11. An information providing method executed by an information providing device, the method comprising:
an auction holding period identifying step of obtaining the number of participants to past auctions of every predetermined time period for other products belonging to a category of a product that an exhibitor wishes to exhibit for an auction, based on action date and time information corresponding to the past auctions of the other products with reference to a storage means that stores the action date and time information indicating dates and times when participants have accessed the past auctions of the other products, and
identifying an auction holding period of the exhibitor based on the number of participants for every predetermined time period a participation frequency of the participants in the past auctions of the every predetermined time period collected from the action date and time information; and
a providing step of providing the auction holding period identified in the auction holding period identifying step to a terminal of the exhibitor.

12. A non-transitory computer-readable recording medium having an information providing program recorded thereon for causing a computer to function as:
an auction holding period identifying means that obtains the number of participants to past auctions of every predetermined time period for other products belonging to a category of a product that an exhibitor wishes to exhibit for an auction, based on action date and time information corresponding to the past auctions of the other products with reference to a storage means that stores the action date and time information indicating dates and times when participants have accessed the past auctions of the other products, and
identifies an auction holding period of the exhibitor based on the number of participants for every predetermined time period a participation frequency of the participants in the past auctions of the every predetermined time period collected from the action date and time information; and
a providing means that provides the auction holding period identified by the auction holding period identifying means to a terminal of the exhibitor.
